(19) United States
(12) Patent Application Publication
(10) Pub. No.: US 2023/0324818 A1
(43) Pub. Date: Oct. 12, 2023

(54) ELECTROPHOTOGRAPHIC PHOTORECEPTOR, PRODUCING METHOD OF ELECTROPHOTOGRAPHIC PHOTORECEPTOR, AND IMAGE FORMING APPARATUS

(71) Applicant: Konica Minolta, Inc., Tokyo (JP)

(72) Inventors: Kazukuni NISHIMURA, Tokyo (JP); Toshiyuki FUJITA, Tokyo (JP); Hiroki TAKAO, Tokyo (JP); Seijiro TAKAHASHI, Tokyo (JP); Tomoko SAKIMURA, Tokyo (JP)

(21) Appl. No.: 18/193,727

(22) Filed: Mar. 31, 2023

(30) Foreign Application Priority Data
Apr. 8, 2022 (JP) 2022-064197

(51) Int. Cl. G03G 5/147; G03G 15/00; G03G 5/047; G03G 5/05; G03G 5/06

(52) U.S. Cl. CPC G03G 5/14708; G03G 15/75; G03G 5/14704; G03G 5/047; G03G 5/0564; G03G 5/06142

(57) ABSTRACT

Provided is an electrophotographic photoreceptor having at least a charge transport layer and a protective layer sequentially laminated on a conductive support, wherein the protective layer contains a cured product of a composition containing a charge transport compound having a chain polymerizable functional group; the charge transport layer and the protective layer are continuously laminated with intervening a mixed layer therebetween in which components of both layers of the charge transport layer and the protective layer are compatible; and the mixed layer has a thickness in the range of 0.1 to 1.0 μm.

### REFERENCE TO RELATED APPLICATIONS

The entire disclosure of Japanese Patent Application No. 2022-064197, filed on Apr. 8, 2022, including description, claims, drawings and abstract is incorporated herein by reference in its entirety.

### TECHNICAL FIELD

The present invention relates to an electrophotographic photoreceptor, a method for producing an electrophotographic photoreceptor, and an image forming apparatus. More specifically, the present invention relates to an electrophotographic photoreceptor that achieves both wear resistance and high image quality in long-term use.

### DESCRIPTION OF THE RELATED ART

In order to achieve both wear resistance and high image quality of an electrophotographic photoreceptor (hereinafter also simply referred to as a “photoreceptor”), a protective layer is known which is obtained by subjecting a charge transport compound having a chain polymerizable group to a curing reaction (see Patent Documents 1 to 3).
Patent Document 1: JP-A 2000-66424
Patent Document 2: JP-A 2005-292560
Patent Document 3: JP-A 2004-302451

However, when the protective layer described in Patent Document 1 was used, sufficient wear resistance was not ensured due to insufficient strength of the protective layer. Further, when the protective layers described in Patent Documents 2 and 3 were used, although the strength of the protective layer was improved and wear resistance was ensured, the hole-transporting ability of the photosensitive layer was still insufficient, resulting in image deterioration. Image memory was likely to occur, and the image quality was insufficient.

As described above, it is not possible to obtain an electrophotographic photoreceptor which is sufficiently satisfactory in wear resistance and high image quality with conventional techniques, and there is a demand for a technique for even higher wear resistance and higher image quality in the electrophotographic photoreceptor.

### SUMMARY OF THE INVENTION

The present invention has been made in view of the above problems and circumstances, and the problem to be solved is to provide an electrophotographic photoreceptor that achieves both wear resistance and high image quality in long-term use, a method for producing the same, and an image forming apparatus equipped with the electrophotographic photoreceptor.

In order to solve the above problems, the present inventors investigated the causes of the above problems and found the following. The protective layer is made to contain a cured product of a composition containing a charge transport compound having a chain polymerizable functional group. By setting the thickness of the interface between the charge transport layer and the protective layer in the range of 0.1 to 1.0 μm, it is possible to provide an electrophotographic photoreceptor that achieves both wear resistance and high image quality in long-term use. This discovery led to the present invention. That is, the above problems related to the present invention are solved by the following means.

An aspect of the present invention is an electrophotographic photoreceptor having at least a charge transport layer and a protective layer sequentially laminated on a conductive support, wherein the protective layer contains a cured product of a composition containing a charge transport compound having a chain polymerizable functional group; the charge transport layer and the protective layer are continuously laminated with intervening a mixed layer therebetween in which components of both layers of the charge transport layer and the protective layer are compatible; and the mixed layer has a thickness in the range of 0.1 to 1.0 μm.

Another aspect of the present invention is a method for producing an electrophotographic photoreceptor having at least a charge transport layer and a protective layer which are sequentially laminated on a conductive support to produce an electrophotographic photoreceptor, the method comprising a step of applying a protective layer-forming coating liquid for forming the protective layer onto the charge transport layer containing at least a binder resin; the protective layer-forming coating liquid contains at least a charge transport compound having a chain polymerizable functional group, Solvent 1, and Solvent 2; and a solubility parameter δ_{B} [(cal/cm³)^{1/2}] of the binder resin, a solubility parameter δ_{S1} [(cal/cm³)^{1/2}] of Solvent 1, and a solubility parameter δ_{S2} [(cal/cm³)^{1/2}] of Solvent 2 satisfy the following Expression 1 and Expression 2,

−3.3≤δ_{S1}−δ_{S}≤−1.3 Expression 1:

−1.3<δ_{S2}−δ_{S}≤0.7. Expression 2:

By the means of the present invention, it is possible to provide an electrophotographic photoreceptor that achieves both wear resistance and high image quality in long-term use.

Although the expression mechanism or the action mechanism of the effects of the present invention has not been clarified, it is speculated as follows.

As described above, in the photoreceptor described in Patent Document 1, sufficient wear resistance was not ensured because the strength of the protective layer is reduced, and in the photoreceptors described in Patent Documents 2 and 3, the hole-transporting ability of the photosensitive layer is insufficient. Image memory is likely to occur. The reasons for these are presumed as follows in view of the method of producing the photoreceptor, especially the solubility parameter δ (SP value) of the protective layer-forming coating liquid solvent and the coating method of the protective layer-forming coating liquid.

The photoreceptor described in Patent Document 1 is manufactured using chlorobenzene (SP value 9.5) and dichloromethane (SP value 9.7) as a coating liquid solvent for forming a protective layer. These solvents have SP values close to the polycarbonate (SP value 9.9) used as the binder resin for the charge transport layer. Therefore, when the protective layer-forming coating liquid is applied onto the charge transport layer by a dip coating, the solvent dissolves the surface layer of the charge transport layer to form a mixed layer having a thickness of more than 1 μm.

At this time, it is expected that a part of the non-reactive charge transport compound (the charge transport compound having no chain polymerizable functional group) present in the charge transport layer is eluted and diffused into the protective layer. In general, the charge transport compound present in the charge transport layer tends to absorb ultraviolet rays, and under such circumstances, the ultraviolet-induced photopolymerization reaction for curing the protective layer is inhibited. As a result, in the photoreceptor described in Patent Document 1, the strength of the protective layer is lowered, and sufficient wear resistance cannot be ensured.

On the other hand, the photoreceptor described in Patent Document 2 is manufactured using heptafluorocyclopentane (SP value 7.2) as a main component of the protective layer-forming coating liquid solvent. In some examples, lower alcohols having a value of 11.5 to 12.7 are used in combination, but the SP values of both are far from the polycarbonate (SP value of 9.9) used as a binder resin of the charge transport layer. Therefore, when the coating liquid for forming a protective layer is applied onto the charge transport layer by a dip coating, the solvent hardly dissolves the surface layer of the charge transport layer. The thickness of the mixed layer in which the components of both the charge transport layer and the protective layer are compatible is less than 0.1 μm.

In addition, in the photoreceptor described in Patent Document 3, a protective layer is formed by a spray coating method. In this case, most of the solvent of the coating liquid for forming a protective layer is vaporized when it adheres to the charge transport layer, so that the charge transport layer and the protective layer are hardly compatible with each other, and the thickness of the mixed layer is less than 0.1 μm.

Since the hole conduction level of each region in the photoreceptor is determined by the HOMO level of the charge transport compound present in that region, the charge transport layer and the protective layer having different charge transport compounds have different hole conduction levels. Further, when the thickness of the mixed layer between the charge transport layer and the protective layer is less than 0.1 μm, there is a region where the hole conduction level changes rapidly in the thickness direction of the photoreceptor. In this region, the ratio of existence of energy barriers to hopping conduction of holes increases, and so-called trap sites for carrier transfer increase. A decrease in the hole-transporting ability of the charge transport layer due to this phenomenon is likely to cause image memory, which is a cause of insufficient image quality.

In the electrophotographic photoreceptor of the present invention, the mixed layer between the charge transport layer and the protective layer has a thickness of 0.1 to 1.0 μm. Since the thickness of the mixed layer is 1.0 μm or less, the elution of the non-reactive charge transport compound (the charge transport compound having no chain polymerizable functional group) present in the charge transport layer into the protective layer can be sufficiently suppressed. As a result, sufficient wear resistance can be ensured. Moreover, since the thickness of the mixed layer is 0.1 μm or more, the energy barrier for charge transport is relaxed, the hole transport ability of the charge transport layer is improved, and the occurrence of image memory can be suppressed.

It is speculated that such a mechanism enables the electrophotographic photoreceptor of the present invention to achieve both wear resistance and high image quality.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic cross-sectional view showing an example of an electrophotographic photoreceptor of the present invention;

FIG. 2 is a graph created for measuring the thickness of the mixed layer in the photoreceptor 1 of Example; and

FIG. 3 is a schematic sectional view showing an example of an image forming apparatus equipped with the electrophotographic photoreceptor of the present invention.

### DETAILED DESCRIPTION

Hereinafter, one or more embodiments of the present invention will be described with reference to the drawings. However, the scope of the invention is not limited to the disclosed embodiments.

The electrophotographic photoreceptor of the present invention is an electrophotographic photoreceptor in which at least a charge transport layer and a protective layer are sequentially laminated on a conductive support, wherein the protective layer contains a cured product of a composition containing a charge transport compound having a chain polymerizable functional group; the charge transport layer and the protective layer are continuously laminated with a mixed layer therebetween in which components of the two layers of the charge transport layer and the protective layer are compatible; and the mixed layer has a thickness in the range of 0.1 to 1.0 μm. This feature is a technical feature common to or corresponding to the following embodiments.

As an embodiment of the electrophotographic photoreceptor of the present invention, it is preferable that the charge transport compound having a chain polymerizable functional group has a structure represented by Formula (1). As a result, a protective layer with sufficient charge transport performance may be formed by applying a simple photo-curing reaction.

As an embodiment of the electrophotographic photoreceptor of the present invention, the protective layer preferably contains inorganic fine particles. Thereby it is possible to further improve the wear resistance of the protective layer.

As an embodiment of the electrophotographic photoreceptor of the present invention, the protective layer preferably contains lubricating organic fine particles. Thereby, it is possible to further improve the wear resistance of the protective layer.

The method for producing an electrophotographic photoreceptor of the present invention is a method for producing an electrophotographic photoreceptor in which at least a charge transport layer and a protective layer are sequentially laminated on a conductive support to produce an electrophotographic photoreceptor, the method comprising a step of applying a protective layer-forming coating liquid for forming the protective layer onto the charge transport layer containing at least a binder resin. The protective layer-forming coating liquid contains at least a charge transport compound having a chain polymerizable functional group, Solvent 1, and Solvent 2, and the solubility parameter δ_{B} [(cal/cm³)^{1/2}] of the binder resin, the solubility parameter δ_{S1} [(cal/cm³)^{1/2}] of Solvent 1, and the solubility parameter δ_{S2} [(cal/cm³)^{1/2}] of Solvent 2 satisfy the following Expression 1 and Expression 2,

−3.3≤δ_{S1}−δ_{B}≤−1.3 Expression 1:

−1.3<δ_{S2}−δ_{B}≤0.7. Expression 2:

As an embodiment of the method for producing an electrophotographic photoreceptor of the present invention, it is preferable that the coating method for the protective layer-forming coating liquid is a slide hopper method or a dip coating method. This makes it easier for the components of both the charge transport layer and the protective layer to moderately dissolve, and makes it easier to adjust the thickness of the mixed layer to 0.1 μm or more. As a result, the energy barrier for charge transport in the region between the charge transport layer and the protective layer is relaxed, the hole transport ability of the charge transport layer is improved, and the occurrence of image memory may be suppressed.

An image forming apparatus of the present invention is an image forming apparatus comprising an electrophotographic photoreceptor, wherein the electrophotographic photoreceptor is the electrophotographic photoreceptor of the present invention.

Hereinafter, the present invention, its components, and the forms and modes for carrying out the present invention will be described in detail. In the present application, “to” is used to mean that the numerical values before and after “to” are included as the lower limit and the upper limit.

<Outline of Electrophotographic Photoreceptor> The electrophotographic photoreceptor of the present invention is an electrophotographic photoreceptor in which at least a charge transport layer and a protective layer are sequentially laminated on a conductive support, wherein the protective layer contains a cured product of a composition containing a charge transport compound having a chain polymerizable functional group; the charge transport layer and the protective layer are continuously laminated with a mixed layer therebetween in which the components of the two layers of the charge transport layer and the protective layer are compatible; and the mixed layer has a thickness of in the range of 0.1 to 1.0 μm.

In the present invention, the charge transport layer may be a layer containing a charge generation compound and serving also as a charge generation layer. When the charge transport layer also serves as the charge generation layer, it is not necessary to have a charge generation layer separate from the charge transport layer between the conductive support and the charge transport layer.

In addition, the photoreceptor of the present invention may further contain layers other than the layers described above. Other layers include, for example, an intermediate layer laminated on the conductive support. The intermediate layer has, for example, a barrier function and an adhesive function.

Examples of specific layer structures of the photoreceptor of the present invention are shown below.
(1) Conductive support/charge generation layer/charge transport layer/mixed layer/protective layer
(2) Conductive support/charge transport layer also serving as charge generation layer/mixed layer/protective layer
(3) Conductive support/intermediate layer/charge generation layer/charge transport layer/mixed layer/protective layer
(4) Conductive support/intermediate layer/charge transport layer also serving as charge generation layer/mixed layer/protective layer

The layer configuration of the electrophotographic photoreceptor of the present invention may be any of the layer configurations (1) to (4), and among these, the layer configuration (3) is particularly preferable.

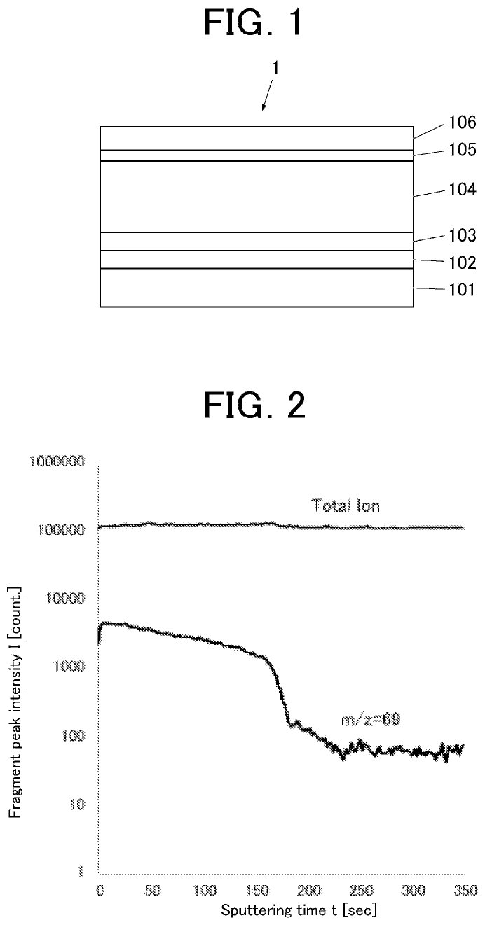

FIG. 1 is a cross-sectional view of an example of the layer configuration of an electrophotographic photoreceptor. The electrophotographic photoreceptor 1 shown in FIG. 1 has an intermediate layer 102, a charge generation layer 103, a charge transport layer 104, and a protective layer 106 sequentially laminated on a conductive support 101, and also has a mixed layer 105 between the charge transport layer 104 and the protective layer 106.

The electrophotographic photoreceptor of the present invention is an organic photoreceptor, which means an electrophotographic photoreceptor in which at least one of the charge generation function and the charge transport function, which are essential for the composition of an electrophotographic photoreceptor, is expressed by an organic compound, and includes photoreceptors composed of known organic charge generation compounds or organic charge transport compounds. It shall include a photoreceptor composed of known organic charge generation or organic charge transport compounds, and a photoreceptor composed of a polymer complex for both charge generation and charge transport functions.

<Protective Layer>

The photoreceptor of the present invention is characterized in that the protective layer contains a cured product of a composition containing a charge transport compound having a chain polymerizable functional group (hereinafter also referred to as a “composition for forming a protective layer”).

In the present invention, “cured product of a composition” refers to a cured product obtained by curing curable components in a composition to form a matrix. When the composition contains solids such as particles, the cured product is composed of the matrix and the solid.

Each component contained in the composition for forming a protective layer will be described below.

(Charge Transport Compound with a Chain Polymerizable Functional Group)

The “charge transport compound having a chain polymerizable functional group” according to the present invention refers to a compound having a charge transport compound as a basic skeleton and at least one or more chain polymerizable functional groups.

The term “charge transport compound” refers to a compound that exhibits charge transport properties. Examples of the charge transport compound that can be a basic skeleton of the “charge transport compound having a chain polymerizable functional group” include triphenylamine derivatives, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl derivatives, hydrazone derivatives, pyrazoline derivatives, oxazolone derivatives, benzimidazole derivatives, quinazoline derivatives, benzofuran derivatives, acridine derivatives, phenazine derivatives, aminostilbene derivatives, phenylenediamine derivatives, stilbene derivatives, and benzidine derivatives.

Among the above charge transport compounds, it is preferred to be a triphenylamine derivative. In the triphenylamine derivative, it is preferred that one of the phenyl groups is a biphenyl group.

The term “chain polymerizable functional group” refers to a functional group capable of reacting through chain polymerization. Chain polymerization mainly includes addition polymerization and ring-opening polymerization.

The term “addition polymerization” is a reaction in which functional groups having unsaturated moieties such as C═C, C≡C, C═O, C═N, and C≡N are chain-polymerized by radicals or ions. It is mainly a reaction in which a functional group having C═C undergoes chain polymerization.

Specific examples of addition polymerizable functional groups are shown below. In the structural formula, an asterisk “*” indicates a bonding moiety. R indicates a hydrogen atom or a substituent such as an alkyl group, an aralkyl group, or an aryl group.

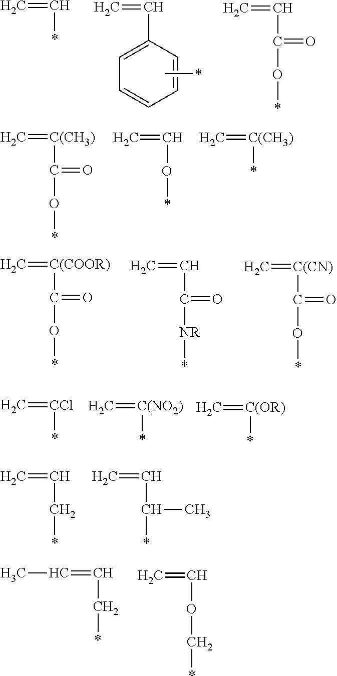

The term “ring-opening polymerization” is a chain polymerization reaction in which a ring structure with a large sterically distorted structure is ring-opened. Specific examples of ring-opening polymerizable functional groups are shown below. In the structural formula, an asterisk “*” indicates a bonding moiety. R indicates a hydrogen atom or a substituent such as an alkyl group, aralkyl group, or aryl group.

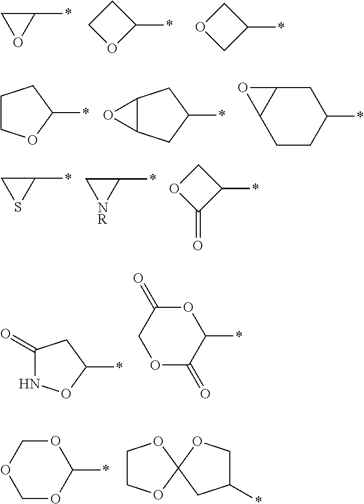

Among the chain polymerizable functional groups mentioned above, addition polymerizable functional groups are preferred, and acryloyloxy groups (CH₂═CHCOO—) or methacryloyloxy groups (CH₂═C(CH₃)COO—) are more preferred.

The “charge transport compound having a chain polymerizable functional group” according to the present invention is not limited to a specific compound, and may be a compound including any combination of a charge transport compound serving as a basic skeleton and a chain polymerizable functional group. In addition, it may have other substituents or linking groups.

The “charge transport compound having a chain polymerizable functional group” according to the present invention is not limited to a specific compound as described above, but it is preferred to have a structure represented by the following Formula (1). For charge transport compounds in general electrophotographic photoreceptors, compounds having a relatively large π-conjugated skeleton are generally used from the viewpoint of improving charge transport performance. However, such charge transport compounds of general electrophotographic photoreceptors have strong absorption of light at a wavelength of 360 to 400 nm, which is suitably used in light-curing reactions, making it difficult to apply light-curing reactions to the formation of layers containing such compounds. In contrast, the structure represented by Formula (1) does not absorb light at a wavelength of 360 to 400 nm, and its charge transport performance is at the same level as that of charge transportable compounds in general electrophotographic photoreceptors. Therefore, when using a charge transport compound having the structure represented by Formula (1), a protective layer with sufficient charge transport performance may be formed by applying a photo-curing reaction, which is a simple method.

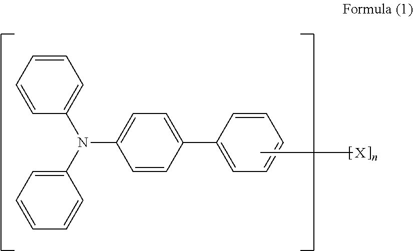

In Formula (1), a substituent X of an aryl group represents an acryloyloxy group or a methacryloyloxy group, which may have an alkylene group, an oxyalkylene group, or a polyoxyalkylene group between the aryl group, n represents an integer of 1 to 3. A hydrogen atom of the aryl group may be substituted with an alkyl group of 1 to 10 carbons, an alkoxy group of 1 to 10 carbons, or a halogeno group, in addition to the substituent X.

The substituent X represents an acryloyloxy group or a methacryloyloxy group, which is a chain polymerizable functional group, but may have an alkylene group, an oxyalkylene group, or a polyoxyalkylene group between the aryl group.

The alkylene group that may be possessed by the substituent X is a linking group having the structure represented by —(CH₂)ₙ—. When the substituent X has an alkylene group, n in —(CH₂)ₙ— is preferably an integer of 1 to 6, and an integer of 1 to 3 is more preferred.

An oxyalkylene group or a polyoxyalkylene group which may be possessed by the substituent X is a linking group having the structure represented by —(OCH₂CH₂)ₙ—. In —(OCH₂CH₂)ₙ—, when n is 1, it is referred to as an oxyalkylene group and when n is 2 or more, it is referred to as a polyoxyalkylene group. When the substituent X has an oxyalkylene group or a polyoxyalkylene group, n in —(OCH₂CH₂)ₙ— is preferably an integer of 1 to 6, and more preferably from 1 to 3.

Examples of the alkyl group having 1 to 10 carbon atoms with which a hydrogen atom of the aryl group may be substituted include a methyl group, an ethyl group, an n-propyl group, an n-butyl group, an n-pentyl group, an n-hexyl group, an n-heptyl group, an n-octyl group, an n-nonyl group, an n-decyl group, an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group. Among these, lower alkyl groups such as a methyl group, an ethyl group, and an isopropyl groups are preferred.

Examples of the alkoxy group having 1 to 10 carbon atoms with which a hydrogen atom of the aryl group may be substituted include a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an iso decyloxy group, a sec-decyloxy group, and a tert-decyloxy group. Among these, a methoxy group or an ethoxy group is preferable.

The halogeno group with which the hydrogen atom of the aryl group can be substituted includes a fluoro group, a chloro group, a bromo group, and an iodo group.

The structures of “charge transport compounds having a chain polymerizable functional group” according to the present invention are exemplified below. Of these, T-1 to T-13 correspond to the structures represented by Formula (1).

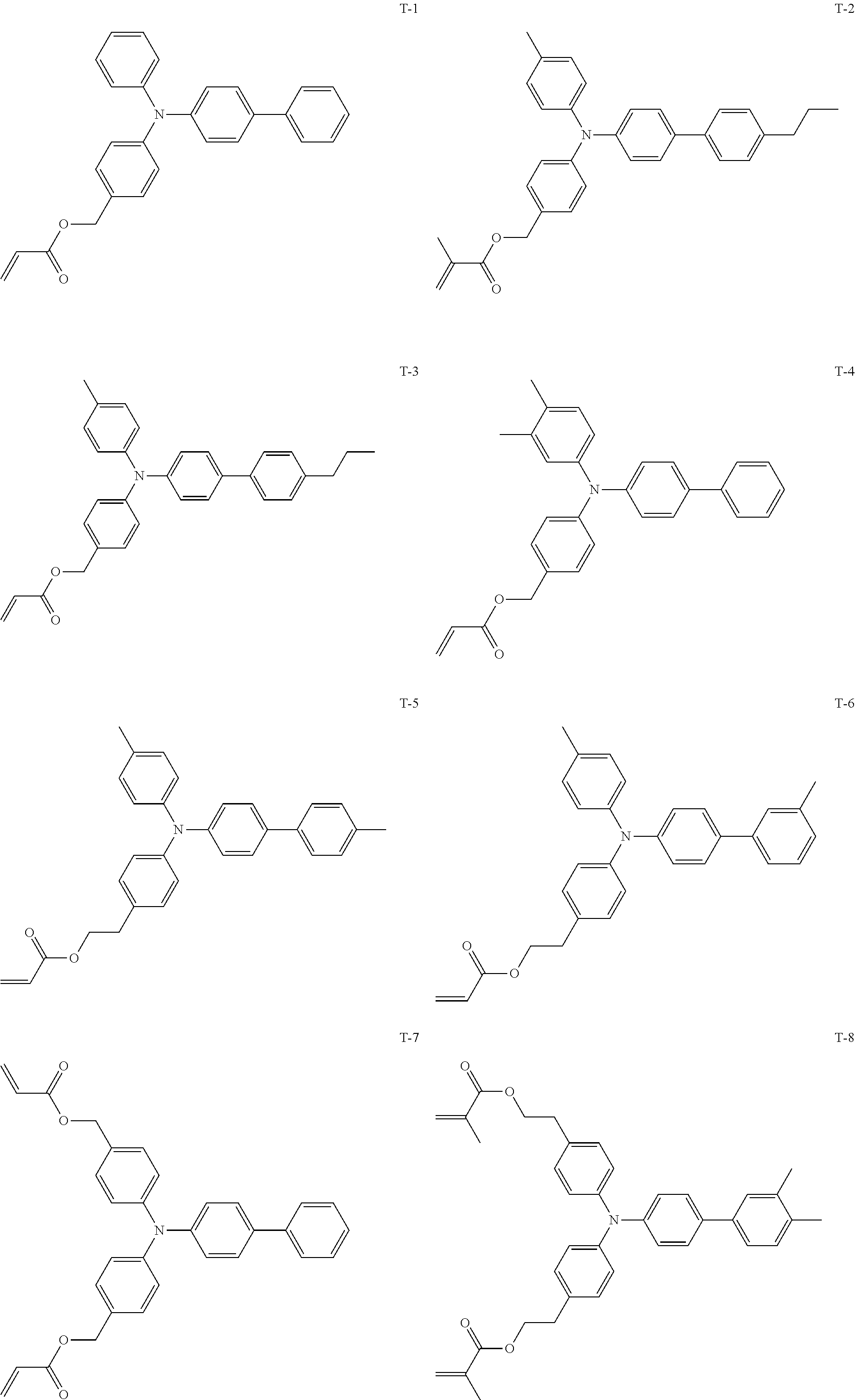

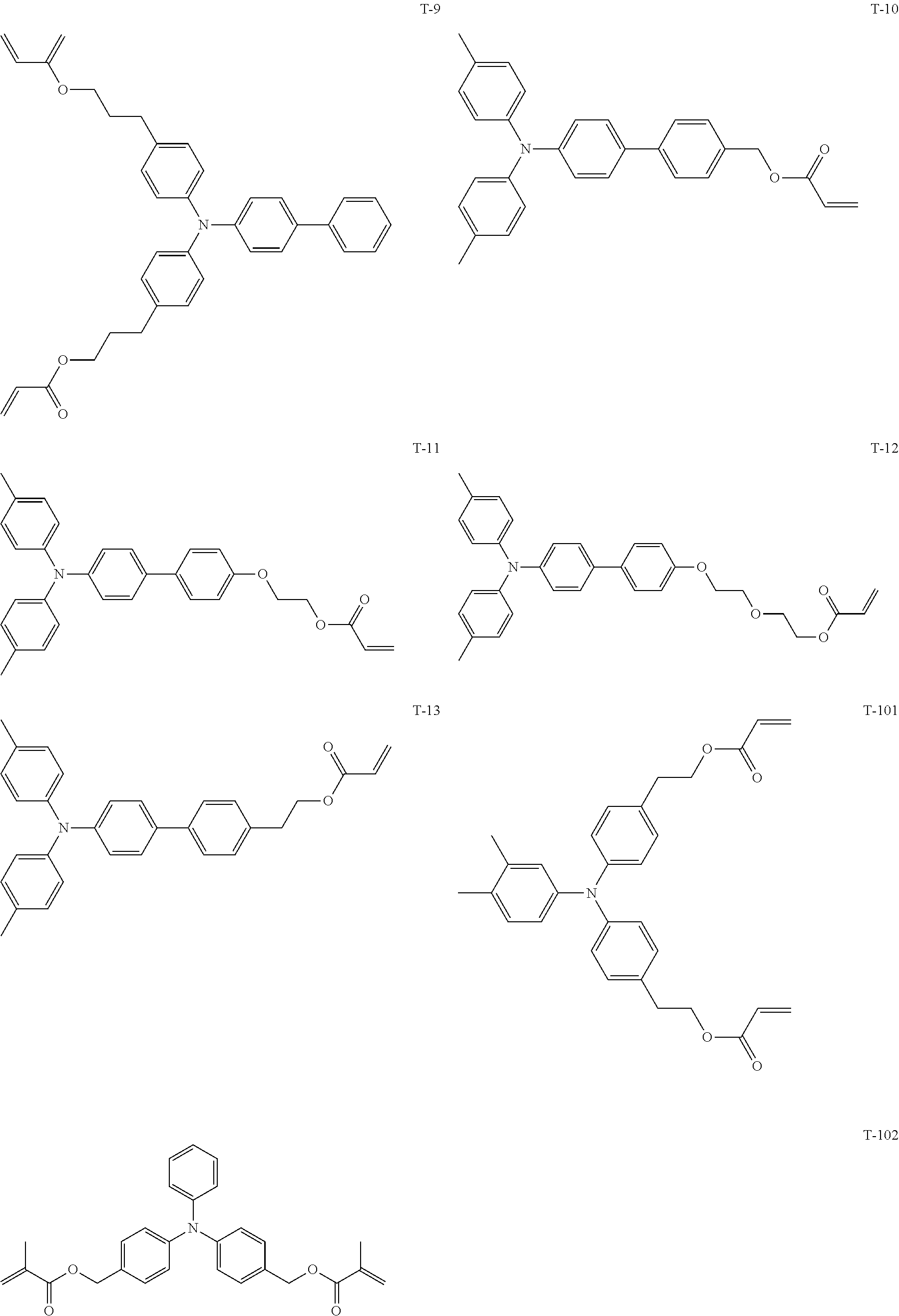

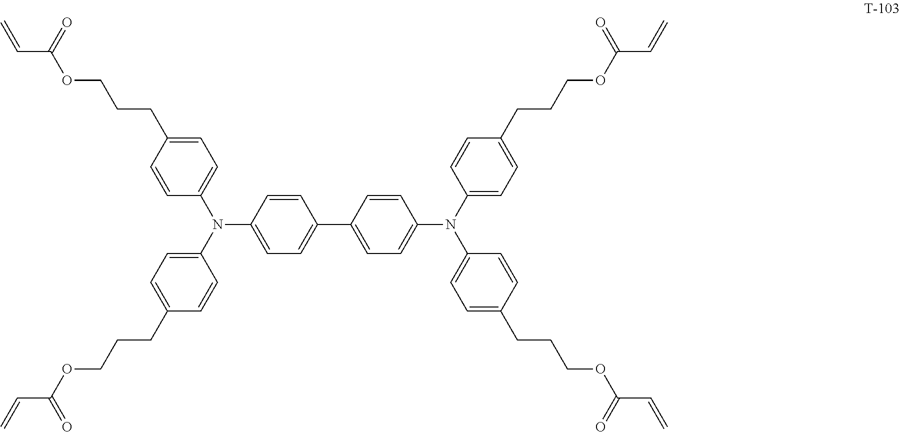 [SMILES: C=CC(=O)OCCCc1ccc(N(c2ccc(CCCOC(=O)C=C)cc2)c2ccc(-c3ccc(N(c4ccc(CCCOC(=O)C=C)cc4)c4ccc(CCCOC(=O)C=C)cc4)cc3)cc2)cc1]

Charge transport compounds with a chain polymerizable functional group may be synthesized using known methods. For example, a compound having structure T-3 may be synthesized by the esterification reaction of an N,N-diphenyl-N-biphenylamine derivative having a hydroxy group with acrylic acid chloride, as shown in the reaction scheme below.

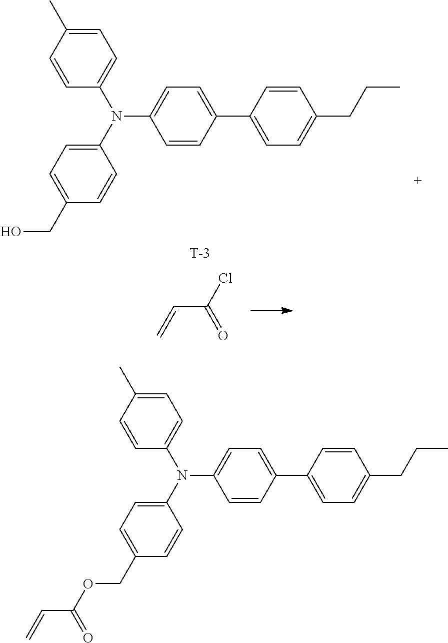

The content ratio of the charge transport compound having a chain polymerizable functional group in the composition for forming a protective layer is preferably in the range of 10 to 90 mass %, and more preferably in the range of 20 to 80 mass % with respect to the total composition for forming a protective layer. When the above content ratio is 10 mass % or more, sufficient charge transport properties may be obtained, and thereby sufficient memory resistance may be obtained. Also, by having a content of 90 mass % or less, sufficient crosslink density of the protective layer may be obtained, thereby providing sufficient wear resistance.

It is possible to confirm that the protective layer contains a cured product of a composition containing a charge transport compound having a chain polymerizable functional group by subjecting the alkaline hydrolyzed product obtained by alkaline hydrolysis of the protective layer to known instrumental analysis such as NMR, IR, and mass spectrometry.

(Trifunctional or More Polymerizable Monomer)

It is preferred that the composition for forming a protective layer according to the present invention contain trifunctional or more polymerizable monomers apart from the charge transport compound having a chain polymerizable functional group. The term “polymerizable monomer” refers to a compound that has a polymerizable group and polymerizes (cures) by irradiation with active energy rays such as ultraviolet rays, visible light rays, and electron beams, or by the addition of energy such as heating.

The trifunctional or more polymerizable monomers may be compounds that polymerize only among molecules of trifunctional or more polymerizable monomers to introduce a three-dimensional mesh structure in the matrix of the protective layer. The trifunctional or more polymerizable monomers may also be compounds that polymerize together with the charge transport compound to introduce a three-dimensional mesh structure in the matrix of the protective layer. This increases the crosslink density of the matrix of the protective layer, resulting in a protective layer with high hardness and high elasticity, and achieving higher wear resistance and scratch resistance.

The polymerizable groups possessed by trifunctional or more polymerizable monomers are preferably addition polymerizable functional groups. Among addition polymerizable functional groups, acryloyloxy groups (CH₂═CHCOO—) or methacryloyloxy groups (CH₂═C(CH₃)COO—) are particularly preferred because they enable curing in a small amount of light or short time.

It is preferred that the portions other than the polymerizable groups in the trifunctional or more polymerizable monomers have no charge transport capability. In other words, it is preferable that the trifunctional or more polymerizable monomers have no charge transport ability. From this viewpoint, the portion other than the polymerizable group in the trifunctional or more polymerizable monomers is typically an aliphatic hydrocarbon group that may have an oxygen atom between carbon atoms. It is preferable to be an isocyanuric ring.

The content of the trifunctional or more polymerizable monomer is preferably in the range of 20 to 80 mass %, more preferably in the range of 30 to 70 mass %, based on the total amount of the composition for forming a protective layer. When the content of the trifunctional or more polymerizable monomer is 20 mass % or more, the matrix of the resulting protective layer has a sufficient crosslink density, and the wear resistance of the protective layer is sufficiently improved. When the content of the trifunctional or more polymerizable monomer is 80 mass % or less, the charge transport ability of the protective layer is sufficient without lowering the content of the charge transport compound having a chain polymerizable functional group, and the image memory resistance is excellent.

As trifunctional or more polymerizable monomers, specifically, the compounds (compounds M1 to M11) whose structures are shown in M1 to M11 below are cited. However, the present invention is not limited to these.

In each of the following formulas, R represents an acryloyl group (CH₂═CHCO—) and R′ represents a methacryloyl group (CH₂═C(CH₃)CO—).

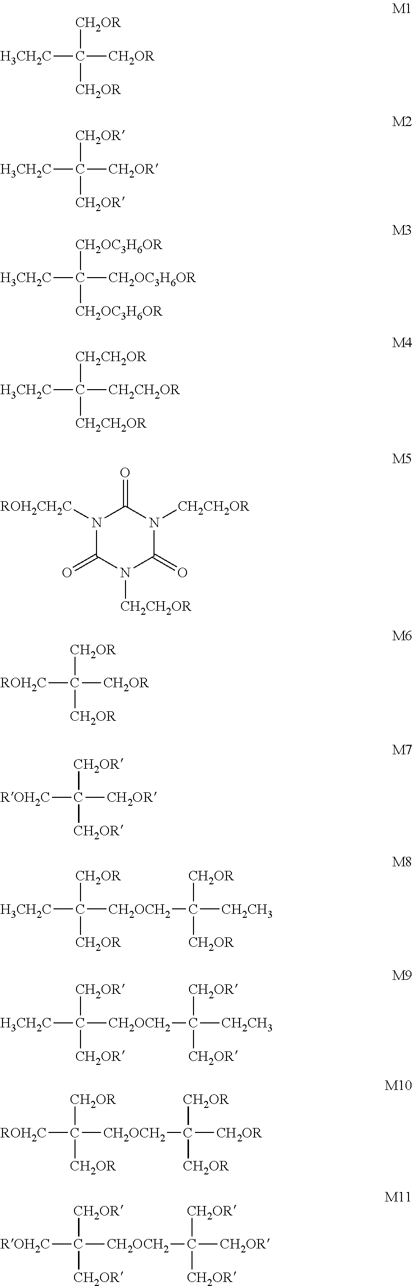

The trifunctional or more polymerizable monomers may be synthetic products or commercially available products. The trifunctional or more polymerizable monomers may be used alone or in combination of two or more.

(Polymerization Initiator)

The polymerization initiator is used to polymerize a polymerizable compound such as a charge transport compound having a chain polymerizable functional group, which is an essential component contained in the composition for forming a protective layer, and a trifunctional or more polymerizable monomer, which is an optional component.

The polymerization initiator is appropriately selected according to the type of polymerizable compound contained in the composition for forming a protective layer. In the present invention, the polymerization initiator may be a thermal or photoinitiator, but a photoinitiator is preferred. It is especially preferred to be a radical polymerization initiator.

As radical polymerization initiators, known ones may be used without restriction, and examples thereof include alkylphenone compounds and phosphine oxide compounds. Among these, compounds having an α-aminoalkylphenone structure or acylphosphine oxide structure are preferred, and compounds having an acylphosphine oxide structure are more preferred. An example of a compound having an acylphosphine oxide structure is Omnirad 819 (bis(2,4,6-trimethylbenzoyl)phenylphosphine oxide, manufactured by IGM Resins B.V.). Polymerization initiators may be used alone or in combination of two or more.

The content of the polymerization initiator in the composition for forming a protective layer is preferably in the range of 0.1 to 20 parts by mass with respect to a total of 100 parts by mass of the polymerizable compound including the charge transport compound having a chain polymerizable functional group and the trifunctional or more polymerizable monomer. It is more preferable to be in the range of 0.5 to 10 parts by mass.

(Inorganic Fine Particulates)

The composition for forming a protective layer in the present invention preferably contains inorganic fine particles. This may further improve the wear resistance of the protective layer.

The number average primary particle diameter of the inorganic fine particles, for example, is preferably in the range of 1 to 300 nm, and 3 to 100 nm is especially preferred.

The particle diameter (number average primary particle diameter) of the inorganic fine particles is determined by taking a magnified photograph of 300 particles at a magnification of 1,000 times using a scanning electron microscope (JEOL), and scanning 300 particles at random (excluding agglomerated particles). The scanned images (excluding agglomerated particles) are binarized using the LUZEX AP (LUZEX (registered trademark) AP) software Ver. 1.32, an automatic image processing and analysis device (Nireco Co., Ltd.). Here, the horizontal directional Feret diameter is the length of the side parallel to the x-axis of the bounding rectangle of the binarized image of the inorganic fine particles.

The content ratio of the inorganic fine particles in the composition for forming a protective layer is preferably in the range of 1 to 100 parts by mass with respect to a total of 100 parts by mass of a polymerizable compound containing a charge transport compound having a chain polymerizable functional group and a polymerizable monomer having three or more functionalities. It is more preferred to be in the range of 5 to 80 parts by mass. When the content ratio of the inorganic fine particles is within the above range, it is possible to fully satisfy the hardness and the light transmittance of the protective layer. When the content ratio of inorganic fine particles is 1 mass part or more, the hardness of the protective layer is improved and wear resistance is further enhanced; when the content ratio is 100 mass parts or less, the latent image formation is less likely to be affected by a decrease in light transmittance and image defects associated with the agglomeration of inorganic fine particles are less likely to occur.

The inorganic fine particles according to the present invention are preferably metal oxide particles from the viewpoint of wear resistance. Examples of the metal oxide particles include particles of silica (silicon dioxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, molybdenum oxide, and vanadium oxide. Among them, silica particles or tin oxide particles are preferred from the viewpoint of hardness and light transmittance of the protective layer.

The above metal oxide particles are preferably metal oxide particles that have been surface-modified by a surface modifier so that a surface having a functional group that reacts with a polymerizable compound containing a charge transport compound having a chain polymerizable functional group and a polymerizable monomer having three or more functionalities is obtained. This allows the surface-modified metal oxide particles to react with the polymerizable compound when forming the protective layer. Thereby it is possible that the metal oxide particles are fixed to the matrix to form a stronger protective layer.

In addition to the functional group that reacts with the polymerizable compound, the surface modifier preferably have a functional group that reacts with a hydroxy group on the metal oxide particle surface. The functional group that reacts with a hydroxy group on the metal oxide particle surface includes a hydrolyzable silyl group. Examples of such surface modifiers include silane coupling agents and titanium coupling agents.

For example, when the polymerizable group of the polymerizable compound is an addition polymerizable functional group, a silane coupling agent having an addition polymerizable functional group and a hydrolyzable silyl group is preferred as a surface modifier. Examples of such surface modifiers include compounds as described below.
S-1: CH₂═CHSi(CH₃)(OCH₃)₂
S-2: CH₂═CHSi(OCH₃)₃
S-3: CH₂═CHSiCl₃
S-4: CH₂═CHCOO(CH₂)₂Si(CH₃)(OCH₃)₂
S-5: CH₂═CHCOO(CH₂)₂Si(OCH₃)₃
S-6: CH₂═CHCOO(CH₂)₃Si(CH₃)(OCH₃)₂
S-7: CH₂═CHCOO(CH₂)₃Si(OCH₃)₃
S-8: CH₂═CHCOO(CH₂)₂ Si(CH₃)Cl₂
S-9: CH₂═CHCOO(CH₂)₂SiCl₃
S-10: CH₂═CHCOO(CH₂)₃Si(CH₃)Cl₂
S-11: CH₂═CHCOO(CH₂)₃SiCl₃
S-12: CH₂═C(CH₃)COO(CH₂)₂Si(CH₃)(OCH₃)₂
S-13: CH₂═C(CH₃)COO(CH₂)₂Si(OCH₃)₃
S-14: CH₂═C(CH₃)COO(CH₂)₃Si(CH₃)(OCH₃)₂
S-15: CH₂═C(CH₃)COO(CH₂)₃Si(OCH₃)₃
S-16: CH₂═C(CH₃)COO(CH₂)₂Si(CH₃)Cl₂
S-17: CH₂═C(CH₃)COO(CH₂)₂SiCl₃
S-18: CH₂═C(CH₃)COO(CH₂)₃Si(CH₃)Cl₂
S-19: CH₂═C(CH₃)COO(CH₂)₃SiCl₃
S-20: CH₂═CHSi(C₂H₅)(OCH₃)₂
S-21: CH₂═C(CH₃)Si(OCH₃)₃
S-22: CH₂═C(CH₃)Si(OC₂H₅)₃
S-23: CH₂═CHSi(OCH₃)₃
S-24: CH₂═C(CH₃)Si(CH₃)(OCH₃)₂
S-25: CH₂═CHSi(CH₃)Cl₂
S-26: CH₂═CHCOOSi(OCH₃)₃
S-27: CH₂═CHCOOSi(OC₂H₅)₃
S-28: CH₂═C(CH₃)COOSi(OCH₃)₃
S-29: CH₂═C(CH₃)COOSi(OC₂H₅)₃
S-30: CH₂═C(CH₃)COO(CH₂)₃Si(OC₂H₅)₃

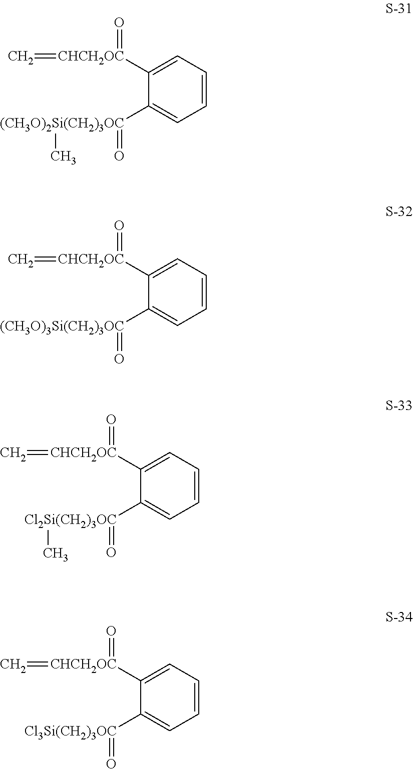

These surface modifiers may be used alone or in a mixture of two or more. The amount of surface modifier used is not particularly limited, but it is preferable to be in the range of 0.1 to 100 parts by mass with respect to 100 parts by mass of metal oxide particles before modification, for example.

Surface modification of metal oxide particles may be specifically performed by wet milling a slurry (suspension of solid particles) containing metal oxide particles and a surface modifier prior to modification, thereby making the metal oxide particles finer and simultaneously progressing the surface modification of the particles, and then removing the solvent to form a powder.

Wet media dispersion type equipment is used for wet milling of slurries. The wet media dispersion type equipment has a process for crushing and dispersing agglomerated metal oxide particles by filling beads as media in a container and rotating an agitation disk attached perpendicularly to the axis of rotation at high speed. As for its configuration, there is no problem as long as it is in a form that allows sufficient dispersion of metal oxide particles and surface modification when performing surface modification on metal oxide particles. For example, various types of equipment such as vertical or horizontal, continuous or batch type may be used. Specifically, a sand mill, an ultra bisco mill, a pearl mill, a glen mill, a dyno mill, a agitator mill, and a dynamic mill may be used. In these dispersing type devices, fine milling and dispersing are performed by impact crushing, friction, shearing, or shear stress using milling media (media) such as balls or beads.

For example, balls made of glass, alumina, zircon, zirconia, steel, or flint stone as raw materials may be used as beads for the wet media dispersion type equipment, but those made of zirconia or zircon are especially preferred. The size of the beads is usually 1 to 2 mm in diameter, but in the present invention, for example, 0.1 to 1.0 mm is preferred.

Various materials such as stainless steel, nylon, and ceramic may be used for the discs and vessel inner walls used in wet media dispersion type equipment, but in the present invention, discs and vessel inner walls made of ceramic such as zirconia or silicon carbide are especially preferred.

(Lubricating Organic Fine Particles)

The composition for forming a protective layer according to the present invention preferably contains lubricating organic fine particles. This may further improve the wear resistance of the protective layer.

For example, fluorine atom-containing resin particles may be used as lubricating organic fine particles. As resin particles containing fluorine atoms, it is preferable to select one or more of the following resins as appropriate: an ethylene tetrafluoride resin, an ethylene trifluoride chloride resin, an ethylene propylene trifluoride resin, an ethylene propylene hexafluoride resin, a vinyl fluoride resin, a vinylidene fluoride resin, an ethylene difluoride resin and their copolymers. An ethylene tetrafluoride resin and a vinylidene fluoride resin are particularly preferred.

The particle size of the lubricating organic fine particles is preferably in the range of 0.01 to 1 μm in number average primary particle diameter. Particularly preferred are those with a number average primary particle diameter of 0.05 to 0.5 μm. The number average primary particle diameter of the lubricating organic fine particles is measured in the same way as for the inorganic fine particles.

The ratio of lubricating organic fine particles in the composition for forming a protective layer is preferably in the range of 5 to 70 parts by mass with respect to 100 parts by mass of the total amount of the above polymerizable compounds, and 10 to 60 parts by mass is more preferred.

(Other Components)

In addition to the essential component, a charge transport compound having a chain polymerizable functional group, and the optional components, a trifunctional or more polymerizable monomer, polymerization initiator, inorganic fine particles, and lubricating organic fine particles, the composition for forming a protective layer may contain other components to the extent not impairing the effect of the invention. Other components include, for example, antioxidants, stabilizers, and silicone oils. As for antioxidants, those disclosed in JP-A 2000-305291 are preferred.

Antioxidants, stabilizers, and silicone oils may be used at a ratio of 0.01 to 50 parts by mass, preferably 0.01 to 40 parts by mass, respectively, to the total 100 parts by mass of the above polymerizable compounds.

When the charge transport layer also serves as the charge generation layer, the charge transport layer contains the charge generator described below.

The thickness of the protective layer is preferably 0.2 to 10 μm, more preferably, it is 0.5 to 6 μm.

<Charge Transport Layer>

The charge transport layer of the present invention is a layer that contains a non-reactive charge transport compound and a binder resin (hereinafter also referred to as a “binder resin for a charge transport layer”).

The “non-reactive charge transport compound” is a charge transport compounds that does not have a chain polymerizable functional group. The chain polymerizable functional groups and charge transporting compounds are described above.

Known resins may be used as the binder resin for a charge transport layer. Examples thereof include a polycarbonate resin, a polyacrylate resin, a polyester resin, a polystyrene resin, a styrene-acrylonitrile copolymer resin, a polymethacrylate resin, and a styrene-methacrylate copolymer resin. A polycarbonate resin is preferably used. Furthermore, BPA (bisphenol A) type, BPZ (bisphenol Z) type, dimethyl BPA type, and BPA-dimethyl BPA copolymer type polycarbonate resins are preferred in terms of crack resistance, wear resistance, and electrification properties.

The content ratio of the non-reactive charge transport compound in the charge transport layer is preferably 10 to 500 parts by mass for 100 parts by mass of the binder resin for a charge transport layer, more preferably 20 to 250 parts by mass.

The charge transport layer may contain antioxidants, electronic conductive agents, stabilizers, and silicone oils. Antioxidants are preferably those disclosed in JP-A 2000-305291, and electronic conductive agents are preferably those disclosed in JP-A 50-137543 and JP-A 58-76483.

The thickness of the charge transport layer depends on the characteristics of the non-reactive charge transport compound, the binder resin for a charge transport layer, and the content ratio, but it is preferably 5 to 40 μm, more preferably it is 10 to 30 μm.

<Mixed Layer in which the Components of the Protective Layer and the Charge Transport Layer are Compatible with Each Other>

The photoreceptor of the present invention is characterized in that the charge transport layer and the protective layer are continuously laminated with a mixed layer therebetween in which the components of the two layers of the charge transport layer and the protective layer are compatible, and the thickness of the mixed layer is in the range of 0.1 to 1.0 μm.

It is thought that a mixed layer thickness of 1.0 μm or less can sufficiently suppress elution of non-reactive charge transport compounds present in the charge transport layer into the protective layer, thus ensuring sufficient wear resistance. In addition, it is thought that the thickness of the mixed layer of 0.1 μm or more relaxes the energy barrier of charge transport and improves the hole transport capacity of the charge transport layer, thereby suppressing the generation of image memory. This allows the photoreceptor of the present invention to achieve both wear resistance and high image quality in long-term use.

The thickness of the mixed layer is characterized by being in the range of 0.1 to 1.0 μm, but from the viewpoint of achieving both wear resistance and higher image quality at a higher level, it is preferred to be in the range of 0.2 to 0.6 μm.

The thickness of the mixed layer may be measured by the following method.

Using a ToF-SIMS (time-of-flight secondary ion mass spectrometry) system, the mass spectrometry peak intensities in each region of the photoreceptor in the thickness direction are measured while the photoreceptor surface is scraped off at a constant speed by sputtering.

Based on the measured mass spectrometry peak intensity, the chemical structure that has the highest fragment peak intensity I [count.] when the layer containing the chemical structure is sputtered is selected as the chemical structure for thickness measurement among the chemical structures contained in only one of the layers, the protective layer and the charge transport layer.

The fragment peak intensity of the selected chemical structure for thickness measurement is plotted with the sputtering time t [sec] on the horizontal axis and the logarithm of the fragment peak intensity I [count.] on the vertical axis, and an approximate curve is created based on the plot to create a graph as shown in FIG. 2. The horizontal axis is set to 0 at the time when sputtering is started. The “scatter diagram (smooth line)” in Microsoft Excel 2013 may be used to create the approximate curve.

The graph shown in FIG. 2 is a graph of the measurement in the example photoreceptor 1. The sputtering speed was 0.02 μm/sec. As the chemical structure for thickness measurement, the chemical structure derived from the methacrylic group possessed by trimethylolpropane trimethacrylate was selected. Therefore, the graph shown in FIG. 2 is a graph of fragment peak intensity at m/z=69, which is attributed to the chemical structure derived from the methacryl group.

From the graph created, find the range of sputtering time t where the fragment peak intensity changes significantly, and consider this range of sputtering time t as the time when the mixed layer was sputtered. Specifically, first, the point at which the absolute value of d(log(I))/dt is the largest is determined as the inflection point. When calculating the value of d(log(I))/dt, the average value of a total of five points including the two points before and after is used as the value of log(I). This allows the exclusion of data points with small values of intensity I and large apparent d(log(I))/dt due to measurement noise. Next, the range of sputtering times t is determined where the absolute value of the slope d(log(I))/dt before and after the inflection point is greater than ¼ of the absolute value of d(log(I))/dt at the inflection point. This range is regarded as the time when the mixed layer was sputtered.

For example, in the graph shown in FIG. 2, the inflection point is reached at t=176 sec. At this inflection point, d(log(I))/dt is −2.84, and ¼ of this value is 0.71. Therefore, the range of sputtering time t where the absolute value of d(log(I)/dt) is greater than 0.71 is considered to be the time when the mixed layer was sputtered. Therefore, the time when the mixed layer was sputtered may be regarded as 22 sec from 162 sec to 184 sec.

The thickness of the mixed layer is calculated from the time during which the mixed layer is sputtered and the sputtering speed.

For example, in the graph shown in FIG. 2, the time when the mixed layer was sputtered was 22 sec and the sputtering speed was 0.02 μm/sec, so the thickness of the mixed layer is obtained as 0.44 μm.

If the inflection point is unclear and cannot be observed, the degree of compatibility between the protective layer and the charge transport layer is considered to be too great and the thickness of the mixed layer is considered to exceed 1.0 μm.

<Charge Generation Layer>

The charge generation layer is a layer containing a charge transport agent and a binder resin (hereinafter also referred to as a “binder resin for a charge generation layer”).

Examples of the charge generator include azo pigments such as Sudan red and Diane blue, quinone pigments such as pyrene quinone and anthroanthrone, quinocyanine pigments, perylene pigments, indigo pigments such as indigo and thioindigo, polycyclic quinone pigments such as pyranuron and diphthaloylpyrene, phthalocyanine pigments such as pyranuron and diphthaloylpyrene, and phthalocyanine pigments. The charge generators are not limited to these. Among these, polycyclic quinone pigments and titanyl phthalocyanine pigments are preferred. One or more of these charge generators may be used alone or in a mixture of two or more.

Examples of the binder resin for a charge generation layer include a polystyrene resin, a polyethylene resin, a polypropylene resin, an acrylic resin, a methacrylic resin, a vinyl chloride resin, a vinyl acetate resin, a polyvinyl butyral resin, an epoxy resin, a polyurethane resin, a phenol resin, a polyester resin, an alkyd resin, a polycarbonate resin, a silicone resin, a melamine resin, a copolymer resin containing two or more of these resins (e.g., a vinyl chloride-vinyl acetate copolymer resin and a vinyl chloride-vinyl acetate-maleic anhydride copolymer resin), and a poly-vinylcarbazole resin. The binder resins are not limited to these. Among these, a polyvinyl butyral resin is preferred.

The ratio of the charge generator in the charge generation layer is preferably in the range of 1 to 600 parts by mass for 100 parts by mass of the binder resin for the charge generation layer, more preferably 50 to 500 parts by mass.

The thickness of the charge generation layer varies depending on the characteristics of the charge generator, the binder resin for a charge generation layer, and the content ratio, but it is preferably from 0.01 to 5 μm, and more preferably from 0.05 to 3 μm.

<Intermediate Layer>

The intermediate layer has a function of enhancing a barrier property or adhesiveness between the conductive support and the charge generation layer or the charge transport layer also serving as the charge generation layer. In the photoreceptor of the present invention, the intermediate layer is not an essential component, but in consideration of prevention of various failures, the intermediate layer is preferably provided.

Such an intermediate layer is, for example, a binder resin (hereinafter also referred to as a “binder resin for an intermediate layer”) and, if necessary, conductive particles or metal oxide particles are contained in this layer.

Examples of the binder resins for an intermediate layer include casein, polyvinyl alcohol, nitrocellulose, ethylene-acrylic acid copolymer, polyamide resin, polyurethane resin, and gelatin. Among these, an alcohol soluble polyamide resin is preferred.

The intermediate layer may contain various conductive particles or metal oxide particles for the purpose of resistance adjustment. For example, various metal oxide particles such as alumina, zinc oxide, titanium oxide, tin oxide, antimony oxide, indium oxide, bismuth oxide, and zirconium oxide may be used as metal oxide particles. Composite metal oxide particles such as indium oxide doped with tin and tin oxide doped with antimony may also be used.

The number average primary particle diameter of such metal oxide particles is preferably in the range of 10 to 300 nm, more preferably 20 to 100 nm.

One type of conductive particles or metal oxide particles may be used alone, or two or more types may be used in combination. When two or more types are mixed, they may be in the form of a solid solution or fusion.

The conductive particles or metal oxide particles are preferably contained in a ratio of 20 to 400 parts by mass to 100 parts by mass of binder resin, more preferably 50 to 350 parts by mass.

The thickness of the intermediate layer is preferably 0.1 to 15 μm, more preferably it is 0.3 to 10 μm.

<Conductive Support>

The conductive support that constitutes the photoreceptor for the embodiment of the present invention may be any support that has conductivity.

Examples of the conductive support include metals such as aluminum, copper, chromium, nickel, zinc, and stainless steel formed into drums or sheets. Also cited are metal foil made of aluminum or copper or other metals laminated to plastic film, aluminum, indium oxide or tin oxide vapor-deposited on plastic film, metal plastic film and paper coated with conductive materials alone or together with binder resin to provide a conductive layer.

<Production of Photoreceptor>

The electrophotographic photoreceptor may be produced, for example, by sequentially forming each layer constituting the photoreceptor on a conductive support. The formation of each layer is carried out by the steps of forming a coating film consisting of a coating liquid containing solids (or raw material components thereof) and solvents that constitute each layer and curing the coating film. The specific producing method of the photoreceptor of the present invention is described below, using as an example the producing method of photoreceptor 1 shown in FIG. 1.

Photoreceptor 1 may be manufactured, for example, by the following process.

Process (1): a process of coating a conductive support 101 with a coating liquid for forming an intermediate layer and drying to form an intermediate layer 102.

Process (2): a process of forming a charge generation layer 103 by coating and drying a coating liquid for forming a charge generation layer on a surface of the intermediate layer 102 formed on the conductive support 101.

Process (3): a process of coating a surface of the charge generation layer 103 formed on the intermediate layer 102 with a coating liquid for forming a charge transport layer, and drying to form a charge transport layer 104.

Process (4): a process of applying a coating liquid for forming a protective layer on the charge transport layer 104 to form a coating film, and this coating film is cured to form a mixed layer 105 and a protective layer 106.

[Process (1): Formation of Intermediate layer]

For forming an intermediate layer 102, a binder resin for an intermediate layer is dissolved in a solvent to prepare a coating liquid (hereinafter also referred to as a “coating liquid for forming an intermediate layer”). The coating liquid is then applied to the conductive support 101 to a certain thickness to form a coating film, which is then dried to form an intermediate layer.

An ultrasonic disperser, a ball mill, a sand mill, and a homo mixer may be used as a device of dispersing conductive particles or metal oxide particles in the coating liquid for forming an intermediate layer, but the dispersers are not limited to these.

The coating methods of the coating liquid for forming an intermediate layer include, for example, the well-known methods such as a dip coating method, a spray coating method, a spinner coating method, a bead coating method, a blade coating method, a beam coating method, and a slide hopper method (including a circular slide hopper method). The circular slide hopper method is a method that uses a circular slide hopper. The circular slide hopper method is used for coating the outer surface of cylindrical or cylinder-shaped articles. The circular slide hopper method may be used to apply the coating liquid for forming an intermediate layer to the outer circumference of a drum-shaped conductive support.

The drying method of the coating film may be selected according to the type of solvent and thickness of the coating film, but thermal drying is preferred.

The solvent used in the formation process of the intermediate layer 102 is preferably one that disperses conductive particles or metal oxide particles well and dissolves the binder resin for an intermediate layer. Specifically, alcohol solvents with a carbon number of 1 to 4, such as methanol, ethanol, n-propyl alcohol, isopropyl alcohol, n-butanol, t-butanol, and sec-butanol are preferred because of their excellent solubility in binder resins and coating performance. Benzyl alcohol, toluene, methylene chloride, cyclohexanone, and tetrahydrofuran, may be used in combination with the above solvents to improve preservation and particle dispersion, and they are used as auxiliary solvents that provide favorable effects.

The concentration of the binder resin for an intermediate layer in the coating liquid for forming an intermediate layer is selected according to the thickness and production speed of the intermediate layer 102.

[Process (2): Formation of Charge Generation Layer]

The charge generation layer 103 may be formed by dispersing the charge generator in a solution in which the binder resin for a charge generation layer is dissolved in a solvent to prepare a coating liquid (hereinafter also referred to as a “coating liquid for forming a charge generation layer”). The coating liquid is applied to the intermediate layer 102 to a certain thickness to form a coating film, which may then be dried to form a charge generation layer 103.

For example, an ultrasonic disperser, a ball mill, a sand mill, and a homo mixer may be used as a device of dispersing a charge generator in a coating liquid for forming a charge generation layer, but the dispersers are not limited to these.

Examples of the coating method for applying a coating liquid for forming a charge generation layer include well-known methods such as a dip coating method, a spray coating method, a spinner coating method, a bead coating method, a blade coating method, a beam coating method, and a slide hopper method (including a circular slide hopper method).

The drying method of the coating film may be selected according to the type of solvent and thickness of the coating film, but thermal drying is preferred.

Examples of the solvent used for forming the charge generation layer 103 include toluene, xylene, methylene chloride, 1,2-dichloroethane, methyl ethyl ketone, cyclohexane, ethyl acetate, t-butyl acetate, methanol, ethanol, propanol, butanol, methyl cellosolve, 4-methoxy-4-methyl-2-pentanone, ethyl cellosolve, tetrahydrofuran, 1-dioxane, 1,3-dioxolane, pyridine, and diethylamine. The solvents are not limited to these.

[Process (3): Formation of Charge Transport Layer]

The charge transport layer 104 may be formed by preparing a coating liquid in which a binder resin for a charge transport layer and a charge transport agent are dissolved in a solvent (hereinafter referred to as a “coating liquid for forming a charge transport layer”). The coating liquid is then applied to the charge generation layer 103 to form a coating film at a certain thickness, and the coating film may be dried.

Examples of the coating method of applying a coating liquid for forming a charge transport layer include well-known methods such as a dip coating method, a spray coating method, a spinner coating method, a bead coating method, a blade coating method, a beam coating method, and a slide hopper method (including a circular slide hopper method).

The drying method of the coating film may be selected according to the type of solvent and thickness of the coating film, but thermal drying is preferred.

Examples of the solvent used for the formation of the charge transport layer 104 include toluene, xylene, methylene chloride, 1,2-dichloroethane, methyl ethyl ketone, cyclohexanone, ethyl acetate, butyl acetate, methanol, ethanol, propanol, butanol, tetrahydrofuran, 1,4-dioxane, 1,3-dioxolane, pyridine, and diethylamine. The solvents are not limited to these.

[Process (4): Formation of Mixed Layer and Protective Layer]

In the formation of the mixed layer 105 and the protective layer 106, typically, a coating liquid obtained by adding a solvent to a composition for forming a protective layer (also referred to as a “coating liquid for forming a protective layer”) is used.

The coating liquid for forming a protective layer is prepared by adding a charge transport compound having a chain polymerizable functional group, which is an essential component in the composition for forming a protective layer, and trifunctional or more polymerizable monomers, polymerization initiators, inorganic fine particles, lubricating organic fine particles, which are optional components, in any solvent.

If the composition for forming a protective layer is a liquid composition having a viscosity that may be applied on the charge transport layer, there is no need to use a solvent, and the composition for forming a protective layer itself is used as the coating liquid for forming a protective layer. However, since the photoreceptor of the present invention is characterized by a mixed layer 105 in which the components of the charge transport layer 104 and the protective layer 106 are compatible with each other with a thickness in the range of 0.1 to 1.0 μm, in order to form such a mixed layer 105, the coating liquid for forming a protective layer preferably contain a solvent that dissolves the components of the charge transport layer.

The coating liquid for forming a protective layer is prepared by dissolving or dispersing each of the above components in a solvent. Of the above components, surface-modified metal oxide particles are dispersed in a solvent. An ultrasonic disperser, a ball mill, a sand mill, and a homo mixer may be used as a device of dispersing the surface-modified metal oxide particles in a solvent, but the dispersers are not limited to these.

Any solvent may be used to form a protective layer as long as it may dissolve or disperse each of the above components. Examples thereof include xylene, dichloromethane, methyl ethyl ketone, cyclohexane, ethyl acetate, butyl acetate, methyl cellosolve, ethyl cellosolve, tetrahydrofuran, 1,4-dioxane, 1,3-dioxolane, pyridine, and diethylamine. The solvents are not limited to these.

Among these solvents, it is preferred that the coating liquid for forming a protective layer contains Solvent 1 and Solvent 2 that satisfy the following Expression 1 and Expression 2.

−3.3≤δ_{S1}−δ_{B}≤−1.3 Expression 1:

−1.3<δ_{S2}−δ_{B}≤0.7 Expression 2:
δ_{B}: Solubility parameter of the binder resin for a charge transport layer [(cal/cm³)^{1/2}]
δ_{S1}: Solubility parameter of Solvent 1 [(cal/cm³)^{1/2}]
δ_{S2}: Solubility parameter of Solvent 2 [(cal/cm³)^{1/2}]

The solubility parameter δ (solubility parameter: SP value) is a physical property that measures the compatibility of substances and is given by the following equation using the molecular aggregation energy E and molecular volume V.
δ=(E/V)^{1/2}
δ: Solubility parameter [(cal/cm³)^{1/2}]
E: Molecular cohesive energy [(cal/cm³)^{1/2}]
V: Molecular capacity [cm³/mol]

In the present invention, the solubility parameters of solvents may be cited from SH (Hildebrand solubility parameter) listed in Table 1b of the following known literature A. However, in Table 1b of the publicly known document A, values whose units are (MPa)^{1/2}(=(J/cm³)^{1/2}) are described. Therefore, to convert this value to a value in a unit of (cal/cm³)^{1/2}, it must be divided by 2.05.

Publicly known literature A: CRITICAL COMPILATION OF SCALES OF SOLVENT PARAMETERS. part I. PURE, NON-HYDROGEN BOND DONOR SOLVENTS, Technical Report, J.-L. M. Abboud, R. Notario, Pure Appl. Chem., Vol. 71, No. 4, pp. 645-718, 1999.

In the present invention, the solubility parameters of the binder resin for the charge transport layer may be cited from the following publicly known literature B.

Publicly known literature B: JP-A 2003-89920

When the coating liquid for forming a protective layer contains Solvent 1 and Solvent 2 that satisfy Expression 1 and Expression 2, the compatibility of the components of both the charge transport layer and the protective layer may be moderately suppressed and the thickness of the mixed layer may be adjusted to 1.0 μm or less. This allows to suppress elution of a non-reactive charge transport compound present in the charge transport layer into the protective layer, thus ensuring sufficient wear resistance.

It is more preferred that Solvent 1 and Solvent 2 satisfy the following Expression 1′ and Expression 2′.

−2.0≤δ_{S1}−δ_{B}≤−1.3 Expression 1′:

−1.0≤δ_{S2}−δ_{B}≤0.0 Expression 2′:

The resulting coating liquid for forming a protective layer is then applied to the surface of the charge transport layer 104 formed by Process (3) to form a coating film.

Examples of the coating method of applying the coating liquid for forming a protective layer include known methods such as a slide hopper method (including a circular slide hopper method), an immersion coating method, a spray coating method, a spinner coating method, a bead coating method, a blade coating method, and a beam coating method.

Among these coating methods, a slide hopper method or an immersion coating method is preferred. When the coating method of the coating liquid for forming a protective layer is the slide hopper method or the immersion coating method, it is easier for the components of both the charge transport layer and the protective layer to compatibilize appropriately, and it is easier to adjust the thickness of the mixed layer to 0.1 μm or more. This relaxes the energy barrier of charge transport in the region between the charge transport layer and the protective layer, improving the hole transport capacity of the charge transport layer and suppressing image memory generation.

As a coating apparatus by the slide hopper method, for example, a circular slide hopper type coating apparatus described in detail in JP-A-58-189061 may be used.

Then, the protective layer 106 may be formed by reacting the reactive components in the coating film and curing the coating film. At the same time as the protective layer 106 is formed, a mixed layer 105 is formed between the charge transport layer 104 and the protective layer 106.

In addition to the polymerizable compound, the above reactive components may also include components such as metal oxide particles having reactive organic groups on their surface. When the composition for forming a protective layer contains metal oxide particles having reactive organic groups on the surface, the polymerizable compound reacts with the reactive organic groups on the surface of the metal oxide particles to form a strong bond at the interface between the matrix and the metal oxide particles.

Although curing treatment may be performed on the coating film without drying, it is preferable to perform curing treatment after natural or thermal drying.

Drying conditions may be selected according to the type of solvent, thickness of the coating film, and other factors. The drying temperature is preferably in the range of room temperature (25° C.) to 180° C., especially preferably in the range of 80 to 140° C. The drying time is preferably from 1 to 200 minutes, and especially preferably from 5 to 100 minutes.

In the curing process for curing the coating film, the coating film is irradiated with ultraviolet light to generate radicals, and the charge transport compound having a chain polymerizable functional group is polymerized and reacted. Alternatively, when the composition for forming a protective layer contains a trifunctional or more polymerizable monomer, the charge transport compound having a chain polymerizable functional group is polymerized and reacted with a trifunctional or more polymerizable monomer. When the composition for forming a protective layer contains a trifunctional or more polymerizable monomer, a three-dimensional network structure is introduced into the matrix of the resulting protective layer by forming crosslinking bonds through a crosslinking reaction and curing, resulting in a protective layer with high crosslinking density, high hardness, and high elasticity.

As a UV light source, any light source that generates UV light may be used without restriction. For example, low-pressure mercury lamps, medium-pressure mercury lamps, high-pressure mercury lamps, ultra high-pressure mercury lamps, carbon arc lamps, metal halide lamps, xenon lamps, and flash (pulse) xenon may be used.

Irradiation conditions vary with each lamp, but for example, the UV irradiation dose is usually in the range of 5 to 500 mJ/cm², preferably in the range of 5 to 100 mJ/cm². The power of the lamp is preferably in the range of 0.1 to 5 kW, and especially preferably in the range of 0.5 to 3 kW. The irradiation time to obtain the required UV irradiation dose is, for example, preferably in the range of 0.1 seconds to 10 minutes, and from the viewpoint of work efficiency, 0.1 seconds to 5 minutes is more preferable.

In the process of forming the protective layer, drying may be performed before and after UV irradiation and during UV irradiation, and the timing of drying may be selected from a combination of these options.

<Image Forming Apparatus>

The image forming apparatus of the present invention is configured to be equipped with the electrophotographic photoreceptor described above. The image forming apparatus of the present invention further comprises, for example, a first charging unit for charging a surface of the electrophotographic photoreceptor, an exposure unit for forming an electrostatic latent image by irradiating light onto the surface of the electrophotographic photoreceptor, a developing unit for developing the electrostatic latent image with a toner to form a toner image, a transfer unit for transferring a toner image onto a transfer material (an image support carrying an image, such as a plain paper and a transparent sheet), a second charging unit for charging the surface of the electrophotographic photoreceptor after transferring the toner image to the transfer material, and a cleaning unit for removing residual toner on the electrophotographic photoreceptor.

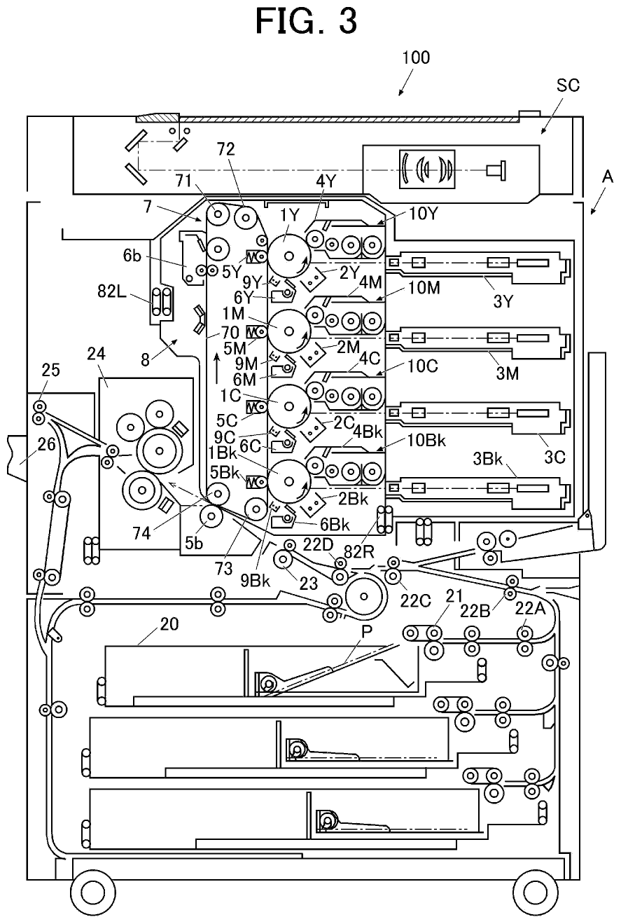

FIG. 3 is a schematic diagram of an example of an image forming apparatus of the present invention. The image forming apparatus 100 is referred to as a tandem-type color image forming apparatus, and is equipped with four sets of image forming units 10Y, 10M, 10C, and 10Bk, an intermediate transfer unit 7, a paper feed unit 21, and a fixing unit 24. A document image reading unit SC is located on the upper part of the apparatus main body A of the image forming apparatus 100.

The image forming unit 10Y, which forms yellow color images, has a first charging unit 2Y, an exposure unit 3Y, a developing unit 4Y, a primary transfer roller 5Y, a second charging unit 9Y, and a cleaning unit 6Y arranged sequentially around a drum-shaped photoreceptor 1Y along the direction of rotation of the photoreceptor 1Y. The image forming unit 10M, which forms magenta color images, has a first charging unit 2M, an exposure unit 3M, a developing unit 4M, a primary transfer roller 5M, a second charging unit 9M, and a cleaning unit 6M, arranged sequentially around a drum-shaped photoreceptor 1M along the direction of rotation of the photoreceptor 1M.

The image forming unit 10C, which forms cyan color images, has a first charging unit 2C, an exposure unit 3C, a developing unit 4C, a primary transfer roller 5C, a second charging unit 9C, and a cleaning unit 6C, arranged sequentially around a drum-shaped photoreceptor 1C along the direction of rotation of the photoreceptor 1C. The image forming unit 10Bk, which forms black images, has a first charging unit 2Bk, an exposure unit 3Bk, a developing unit 4Bk, a primary transfer roller 5Bk, a second charging unit 9Bk, and a cleaning unit 6Bk, which are sequentially arranged around a drum-shaped photoreceptor 1Bk along the direction of rotation of the photoreceptor 1Bk. The electrophotographic photoreceptors 1Y, 1M, 1C, and 1Bk are the electrophotographic photoreceptors of the present invention described above.

The image forming units 10Y, 10M, 10C, and 10Bk are similarly configured, with the only difference being the color of the toner image formed on the photoreceptors 1Y, 1M, 1C, and 1Bk. Therefore, an image forming unit 10Y will be taken as an example and it is explained in detail, while omitting the explanation of image forming units 10M, 10C, and 10Bk.

The image forming unit 10Y forms a yellow (Y) toner image on the photoreceptor 1Y by arranging the first charging unit 2Y, the exposure unit 3Y, the developing unit 4Y, the primary transfer roller 5Y, the second charging unit 9Y, and the cleaning unit 6Y around the photoreceptor 1Y that is an image forming body. In this embodiment, at least the photoreceptor 1Y, the first charging unit 2Y, the developing unit 4Y, the second charging unit 9Y, and the cleaning unit 6Y are integrated in the image forming unit 10Y.

The first charging unit 2Y is a unit to provide a uniform potential to the photoreceptor 1Y. For example, a corona discharge type charger is used.

The exposure unit 3Y is a unit to form an electrostatic latent image corresponding to a yellow image on the photoreceptor bY, which is given a uniform potential by the first charging unit 2Y, by means of exposure based on an image signal (yellow). As the exposure unit 3Y, for example, an LED consisting of an array of light-emitting elements in the axial direction of the photoreceptor 1Y and an imaging element, or a laser optical system is used.

The developing unit 4Y, for example, consists of a developing sleeve that incorporates a magnet, holds the developer, and rotates, and a voltage-applying device that applies a DC and/or AC bias voltage between the photoreceptor 1Y and the developing sleeve.

The primary transfer roller 5Y is a unit of transferring the toner image formed on the photoreceptor 1Y to the intermediate transfer body 70 in the form of an endless belt. The primary transfer roller 5Y is positioned in contact with the intermediate transfer body 70.

The second charging unit 9Y is a static eliminating unit that electrically charges (eliminates static) the surface of the photoreceptor 1Y after transferring the toner image onto the intermediate transfer body 70, and is provided as a pre-cleaning member. For example, a corona discharge type charger is used as the second charging unit 9Y.

According to the image forming apparatus 100 of the present invention, in addition to being provided with the electrophotographic photoreceptor of the present invention, the second charging unit 9Y is provided to obtain sufficient photoreceptor longevity and high image quality. In addition, the image forming apparatus 100 is equipped with the electrophotographic photoreceptor of the present invention, and sufficient long life of the photoreceptor and high image quality may be obtained even under image forming conditions in which the second charging unit 9Y is not provided or the second charging unit 9Y is not used.

The cleaning unit 6Y consists of a cleaning blade and a brush roller provided on the upstream side of the cleaning blade.

The intermediate transfer unit 7 includes an intermediate transfer body 70 in the form of an endless belt as a second image bearing member in the form of a semi-conductive endless belt that is wound by a plurality of rollers 71, 72, 73, and 74 and supported in a rotatable manner. In the intermediate transfer unit 7, a cleaning unit 6b that removes toner on the intermediate transfer body 70 is disposed.

A housing 8 is constituted by the image forming units 10Y, 10M, 10C, and 10Bk and the intermediate transfer unit 7. The housing 8 is configured to be pulled out from the apparatus main body A via support rails 82L and 82R.

The image forming apparatus 100 is equipped with a secondary transfer roller 5b that transfers the color image formed on the intermediate transfer body 70 to the transfer material P. The paper feed unit 21 is a unit for supplying the transfer material P to the secondary transfer roller 5b. The paper feed unit 21 is equipped with a paper feed cassette 20 for storing the transfer material P, a plurality of intermediate rollers 22A, 22B, 22C, 22D, and a resist roller 23 for transporting the transfer material P to the secondary transfer roller 5b.

The fixing unit 24 is a unit for fixing the color image transferred to the transfer material P, and includes, for example, a heat roller fixing system constituted by a heating roller having a heating source therein and a pressure roller provided in a state of being brought into pressure contact with the heating roller so as to form a fixing nip portion. The image forming apparatus 100 includes a paper discharge tray 26 for taking out the transfer material P on which an image is formed, and a paper discharge roller 25 for conveying the transfer material P on which a fixing process is performed to the paper discharge tray 26 on the downstream side of the fixing unit 24.

In the above embodiments, the image forming apparatus 100 is assumed to be a color laser printer, but it may also be a monochrome laser printer, copier, or a multifunction machine. The exposure light source may be a light source other than a laser, such as an LED light source.

<Image Forming Method>

The image forming method is preferably performed using the electrophotographic photoreceptor of the present invention. Specifically, the above image forming apparatus 100 equipped with the electrophotographic photoreceptor of the invention may be used to perform the image forming method as follows.

That is, first, the surfaces of the photoreceptors 1Y, 1M, 1C, and 1Bk are negatively charged by discharging by the first charging units 2Y, 2M, 2C, and 2Bk. Next, the surfaces of the photoreceptors 1Y, 1M, 1C, and 1Bk are exposed by exposure units 3Y, 3M, 3C, and 3Bk based on image signals to form an electrostatic latent image. Next, the developing units 4Y, 4M, 4C, and 4Bk apply toner to the surface of the photoreceptors 1Y, 1M, 1C, and 1Bk to develop the image to form a toner image.

Next, the primary transfer rollers 5Y, 5M, 5C, and 5Bk transfer the toner images of each color formed on the photoreceptor 1Y, 1M, 1C, and 1Bk, respectively, sequentially (primary transfer) onto the rotating intermediate transfer body 70 to form color images on the intermediate transfer body 70.

The surfaces of the photoreceptors 1Y, 1M, 1C, and 1Bk are then ionized by the second charging units 9Y, 9M, 9C, and 9Bk. The remaining toner on the surfaces of the photoreceptors 1Y, 1M, 1C, and 1Bk are then removed by the cleaning units 6Y, 6M, 6C, and 6Bk. Then, the photoreceptors 1Y, 1M, 1C, and 1Bk are negatively charged by the charging units 2Y, 2M, 2C, and 2Bk in preparation for the next image forming process.

Meanwhile, the transfer material P is fed from the paper feed cassette 20 by the paper feed unit 21, and is transferred to the secondary transfer roller 5b through a plurality of intermediate rollers 22A, 22B, 22C, 22D and resist roller 23. The color image is then transferred (secondary transfer) onto the transfer material P by the secondary transfer roller 5b.

After the transfer material P on which the color image has been transferred is fixed by the fixing unit 24, it is sandwiched by the paper discharge roller 25 and discharged out of the device and placed on the paper removal tray 26. After the transfer material P is separated from the intermediate transfer body 70, the remaining toner on the intermediate transfer body 70 is removed by the cleaning unit 6b. In this way, an image may be formed on the transfer material P.

### Examples

Hereinafter, the present invention will be specifically described with reference to Examples, but the present invention is not limited thereto. In the following Examples, unless otherwise specified, operations were performed at room temperature (25° C.), and unless otherwise specified, “%” and “part(s)” mean “mass %” and “part(s) by mass”, respectively.

[Preparation of Electrophotographic Photoreceptor]

A photoreceptor with a layer composition similar to that shown in FIG. 1 was produced by the following method.

<Charge Transport Compound Contained in Protective Layer>

In these examples, compounds having the structures represented by T-3, T-7, T-102, and N-1 below were used as the charge transport compounds contained in the protective layer. The compounds having the structures represented by T-3, T-7, and T-102 are charge transport compounds having a chain polymerizable functional group. The compound having the structure represented by N-1 is a charge transport compound without a chain polymerizable functional group (non-reactive charge transport compound), which was used as a comparison.

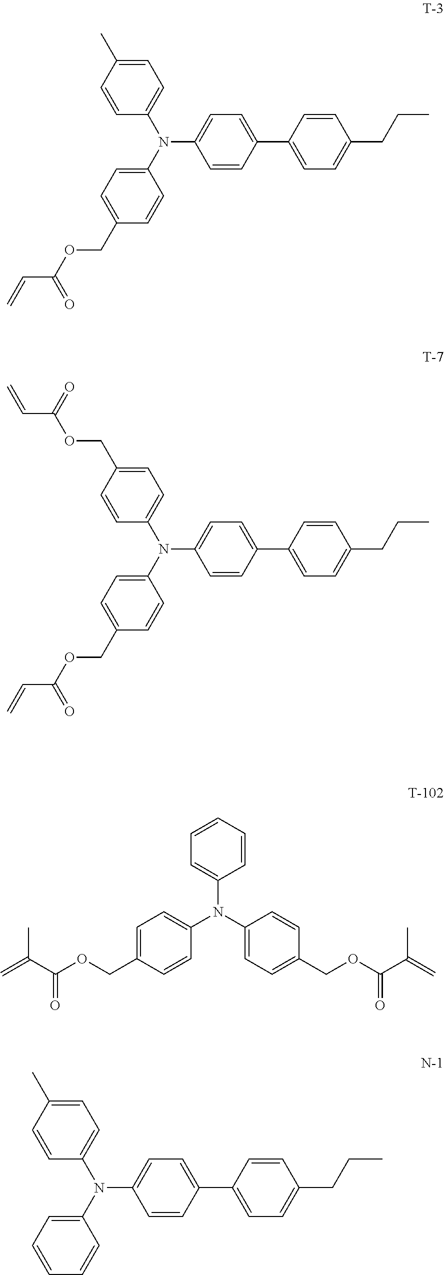

These charge transport compounds were synthesized by the method described in JP-A 2006-143720 and the above method described for producing T-3 as an example.

<Production of Photoreceptor 1>

Photoreceptor 1 was produced as described below.

(Preparation of Conductive Support)

The surface of a cylindrical aluminum support with a diameter of 60 mm was cut to prepare a conductive support with a surface roughness Rz of 1.5 μm.

(Formation of Intermediate Layer)

A mixture of 1 part by mass of polyamide resin CM8000 (manufactured by Toray Industries Inc.), 3 parts by mass of titanium dioxide SMT500SAS (manufactured by Tayca Corporation), and 20 parts by mass of methanol composition was dispersed for 10 hours in a batch system using a sand mill. After standing overnight, the mixture was filtered through a Rigimesh 5 μm filter (manufactured by Pall Corporation) to prepare a coating liquid for forming an intermediate layer. This coating liquid for forming an intermediate layer was applied to a conductive support by a dip coating method so that the thickness after drying was 2 μm, thereby forming an intermediate layer.

(Formation of Charge Generation Layer)

20 parts by mass of titanyl phthalocyanine pigment (titanyl phthalocyanine pigment having a maximum diffraction peak at least at 27.3° as measured by Cu-Kα characteristic X-ray diffraction spectrum) as a charge generator, 10 parts by mass of polyvinyl butyral resin (#6000-C: manufactured by Denka Company Ltd.), 700 parts by mass of t-butyl acetate, and 300 parts by mass of 4-methoxy-4-methyl-2-pentanone were mixed and dispersed for 10 hours using a sand mill to prepare a coating liquid for forming a charge generation layer. This coating liquid for forming a charge generation layer was coated on the intermediate layer by a dip coating method so that the thickness after drying became 0.3 μm. By this, a charge generation layer was formed.

(Formation of Charge Transport Layer)

100 parts by mass of polycarbonate resin Z-300 (manufactured by Mitsubishi Gas Chemical Company, solubility parameter δ_{B}=9.9), which is a copolymer of bisphenol Z, as a binder resin, 50 parts by mass of charge transport compound shown in chemical structure CTM-(1) below, 2 parts by mass of an anti-oxidant (Irganox1010: manufactured by BASF Japan Ltd.), 540 parts by mass of tetrahydrofuran, 135 parts by mass of toluene, and 0.3 parts by mass of silicone oil (KF-54: manufactured by Shin-Etsu Chemical Co., Ltd.) were mixed and dissolved to prepare a coating liquid for forming a charge transport layer. This coating liquid for forming a charge transport layer was applied over the charge generation layer by a dipping coating method so that the thickness after drying became 25 μm. By this, a charge transport layer was formed. The thickness of 25 μm includes the part of the layer that is mixed with the components of the protective layer by compatibility.

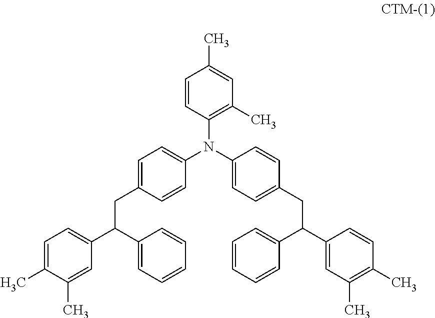

(Formation of Protective Layer)

The following components were mixed and stirred, thoroughly dissolved and dispersed to prepare a coating liquid for forming a protective layer.
Solvent 1: Cyclohexane (δ_{S1}=8.2): 100 parts by mass
Solvent 2: Tetrahydrofuran (δ_{S2}=9.1): 100 parts by mass
Charge transport compound, Chemical structure T-3: 50 parts by mass
Trifunctional or more polymerizable monomer: SR350 (manufactured by Sartomer Co.): 50 parts by mass
Photoinitiator: Omnirad819 (manufactured by IGM Resins B.V.): 5 parts by mass

SR350 (manufactured by Sartomer Co.) used as a trifunctional or more polymerizable monomer is trimethylolpropane trimethacrylate represented by the chemical structure M1.

The prepared coating liquid for forming a protective layer was applied on the charge transport layer using a circular slide hopper coating system to obtain a thickness of 3.5 μm after drying. Then, UV light was irradiated using a metal halide lamp for 1 minute, followed by drying at 110° C. for 70 minutes. Thereby formed a protective layer. The thickness of 3.5 μm includes the part of the layer that becomes a mixed layer by compatibility with the components of the charge transport layer.

<Preparation of Photoreceptors 2 to 9>

In forming the protective layer of Photoreceptor 1 above, Solvent 1, Solvent 2, and the type of charge transport compound were changed respectively as described in the table below, and Photoreceptors 2 to 9 were made in the same way.

<Preparation of Photoreceptor 10>

100 parts of silica particles (AEROSIL RM50, manufactured by AEROSIL Japan, primary average particle size 40 nm), 30 parts of the above surface modifier S-15 (methacrylic compound), and 300 parts of a mixed solvent of toluene/isopropyl alcohol=1/1 (mass ratio) were placed in a sand mill together with zirconia beads and stirred at a rotational speed of 1500 rpm at about 40° C. The mixture was taken out and put into a Henschel mixer, stirred at a rotational speed of 1500 rpm for 15 minutes, and then dried at 120° C. for 3 hours. The surface of the silica particles was coated with surface modifier 5-15, which was confirmed by detecting the Si peak using an X-ray fluorescence analyzer (XRF-1700, manufactured by Shimadzu Corporation).

A coating liquid for forming a protective layer was prepared by changing the amount of tetrahydrofuran to 20 parts by mass in the coating liquid for forming a protective layer of Photoreceptor 1. A dispersion liquid obtained by ultrasonically dispersing 20 parts by mass of the surface-modified silica particles as inorganic fine particles in 80 parts by mass of tetrahydrofuran was mixed with the above solution to prepare a coating liquid for forming a protective layer. Photoreceptor 10 was produced by the same operation as in the preparation of Photoreceptor 1.

<Preparation of Photoreceptor 11>

A coating liquid for forming a protective layer was prepared by changing the amount of tetrahydrofuran to 20 parts by mass in the coating liquid for forming a protective layer of Photoreceptor 2. A dispersion liquid obtained by ultrasonically dispersing 20 parts by mass of the surface-modified silica particles as inorganic fine particles in 80 parts by mass of tetrahydrofuran was mixed with the above solution to prepare a coating liquid for forming a protective layer. Photoreceptor 11 was prepared by the same operation as in the preparation of Photoreceptor 2.

<Preparation of Photoreceptor 12>

100 parts of tin oxide particles (manufactured by CIK Nanotech, primary average particle diameter 20 nm, volume resistivity 1.05×10⁵ Ω-cm), 30 parts of the above surface modifier 5-15 (methacrylic compound), and 300 parts of a mixed solvent of toluene/isopropyl alcohol=1/1 (mass ratio) were placed in a sand mill together with zirconia beads and stirred at a rotational speed of 1500 rpm at about 40° C. The mixture was taken out and put into a Henschel mixer, stirred at a rotational speed of 1500 rpm for 15 minutes, and then dried at 120° C. for 3 hours. The surface of the tin oxide particles was coated with surface modifier 5-15, which was confirmed by detecting the Si peak using an X-ray fluorescence analyzer (XRF-1700, manufactured by Shimadzu Corporation).

A coating liquid for forming a protective layer was prepared by changing the amount of tetrahydrofuran to 20 parts by mass in the coating liquid for forming a protective layer of Photoreceptor 1. A dispersion liquid obtained by ultrasonically dispersing 20 parts by mass of the surface-modified silica particles as inorganic fine particles in 80 parts by mass of tetrahydrofuran was mixed with the above solution to prepare a coating liquid for forming a protective layer. Photoreceptor 12 was prepared by the same operation as in the preparation of Photoreceptor 1.

<Preparation of Photoreceptor 13>

0.5 parts by mass of a fluorine atom-containing polymer (GF-300, manufactured by Toagosei Co., Ltd.) as a dispersant and 10 parts by mass of tetrafluoroethylene resin particles (PTFE, Lubron L-2, manufactured by Daikin Industries, Ltd.) as lubricating organic fine particles were added to the coating liquid for forming a protective layer of Photoreceptor 1, and the mixture was ultrasonically dispersed to prepare a coating liquid for forming a protective layer. Photoreceptor 13 was prepared by the same operation as in the preparation of Photoreceptor 1.

<Preparation of Photoreceptor 14>

Photoreceptor 14 was produced in the same manner as preparation of Photoreceptor 1 except that the coating method was changed to a dip coating method.

<Preparation of Photoreceptor 15>

In the formation of the charge transport layer of the above Photoreceptor 2, Photoreceptor 15 was made in the same way except that the binder resin was changed to 100 parts by mass of polyarylate resin (M-2040, manufactured by Unitika Ltd., solubility parameter δ_{B}=9.2).

<Preparation of Photoreceptor 16>

In the formation of the charge transport layer of the above Photoreceptor 11, Photoreceptor 16 was made in the same way except that the binder resin was changed to 100 parts by mass of polyarylate resin (M-2040, manufactured by Unitika Ltd., solubility parameter δ_{B}=9.2).

### Comparative Examples: Preparation of Photoreceptors 17 to 21

In the formation of the protective layer of Photoreceptor 1 above, Solvent 1, Solvent 2, and the type of charge transport compound were changed respectively as described in the table below, and Photoreceptors 17 to 21 were made in the same way.

### Comparative Example: Preparation of Photoreceptor 22

In the formation of the protective layer of Photoreceptor 18 above, Photoreceptor 22 was made in the same way except that the coating method was changed to a spray coating method.

### Comparative Example: Preparation of Photoreceptor 23

In the formation of the protective layer of Photoreceptor 1 above, Photoreceptor 23 was made in the same way except that the coating method was changed to a spray coating method.

<Measurement of Mixed Layer Thickness>

The thickness of the mixed layer was measured by the following method

Using a PHI TRIFT V nanoTOF (manufactured by ULVAC-PHI Inc.), a ToF-SIMS (time-of-flight secondary ion mass spectrometer) system, the photoreceptor surface was scraped at a constant rate (sputtering speed: 0.02 μm/sec) by sputtering, and the mass spectrometry peak intensities were measured in each region in the photoreceptor thickness direction.

Based on the measured mass spectrometry peak intensities, the chemical structure derived from the methacryl group of trimethylolpropane trimethacrylate, which is contained only in the protective layer, was selected as the chemical structure for thickness measurement.

A graph of fragment peak intensities with m/z=69 due to the chemical structure derived from the methacryl group was created using the “Scatter Plot (Smooth Line)” in Microsoft Excel 2013, with the horizontal axis as the sputter time t [sec] and the vertical axis as the logarithm of the fragment peak intensity I [count.].

From the graph, the inflection point was determined as the point where the absolute value of d(log(I)/dt) was the largest within the range of large changes in fragment peak intensity. When calculating the value of d(log(I))/dt, the average value of five points including the two points before and after the inflection point was used as the log(I) value. Next, the range of sputtering time t where the absolute value of the slope d(log(I))/dt before and after the inflection point is more than ¼ of the absolute value of d(log(I))/dt at the inflection point was determined, and this range was considered as the time when the mixed layer was sputtered.

The thickness of the mixed layer was calculated from the time during which the mixed layer was sputtered and the sputtering speed (0.02 μm/sec). The calculated values are shown in the table below.

TABLE I

| | Charge transport layer | | | | | | | | |
|---|---|---|---|---|---|---|---|---|---|
| | Charge | | | Protective layer | | | | | |
| Photoreceptor | transport | Binder resin | | Solvent 1 | | | Solvent 2 | | |
| No. | compound | Type | δ [symbol] | Type | δ [symbol] | δ [symbol] − δ [symbol] | Type | δ [symbol] | δ [symbol] − δ [symbol] |
| 1 | CTM-1 | Polycarbonate | 9.9 | Cyclohexane | 8.2 | −1.7 | Tetrahydrofuran | 9.3 | −0.6 |
| 2 | CTM-1 | Polycarbonate | 9.9 | Methylcyclohexan | 7.8 | −2.1 | Tetrahydrofuran | 9.3 | −0.6 |
| 3 | CTM-1 | Polycarbonate | 9.9 | Methyl isobutyl | 8.5 | −1.4 | Tetrahydrofuran | 9.3 | −0.6 |
| 4 | CTM-1 | Polycarbonate | 9.9 | Diisopropyl ether | 7.1 | −2.8 | Tetrahydrofuran | 9.3 | −0.6 |
| 5 | CTM-1 | Polycarbonate | 9.9 | Cyclohexane | 8.2 | −1.7 | Toluene | 8.9 | −1.0 |
| 6 | CTM-1 | Polycarbonate | 9.9 | Cyclohexane | 8.2 | −1.7 | Chlorobenzene | 9.5 | −0.4 |
| 7 | CTM-1 | Polycarbonate | 9.9 | Cyclohexane | 8.2 | −1.7 | Cyclopentanone | 10.4 | 0.5 |
| 8 | CTM-1 | Polycarbonate | 9.9 | Cyclohexane | 8.2 | −1.7 | Tetrahydrofuran | 9.3 | −0.6 |
| 9 | CTM-1 | Polycarbonate | 9.9 | Cyclohexane | 8.2 | −1.7 | Tetrahydrofuran | 9.3 | −0.6 |
| 10 | CTM-1 | Polycarbonate | 9.9 | Cyclohexane | 8.2 | −1.7 | Tetrahydrofuran | 9.3 | −0.6 |
| 11 | CTM-1 | Polycarbonate | 9.9 | Methylcyclohexan | 7.8 | −2.1 | Tetrahydrofuran | 9.3 | −0.6 |
| 12 | CTM-1 | Polycarbonate | 9.9 | Cyclohexane | 8.2 | −1.7 | Tetrahydrofuran | 9.3 | −0.6 |
| 13 | CTM-1 | Polycarbonate | 9.9 | Cyclohexane | 8.2 | −1.7 | Tetrahydrofuran | 9.3 | −0.6 |
| 14 | CTM-1 | Polycarbonate | 9.9 | Cyclohexane | 8.2 | −1.7 | Tetrahydrofuran | 9.3 | −0.6 |
| 15 | CTM-1 | Polyarylate | 9.2 | Methylcyclohexan | 7.8 | −1.4 | Tetrahydrofuran | 9.3 | 0.1 |
| 16 | CTM-1 | Polyarylate | 9.2 | Methylcyclohexan | 7.8 | −1.4 | Tetrahydrofuran | 9.3 | 0.1 |
| 17 | CTM-1 | Polycarbonate | 9.9 | Cyclohexane | 8.2 | −1.7 | None | — | — |
| 18 | CTM-1 | Polycarbonate | 9.9 | None | — | — | Tetrahydrofuran | 9.3 | −0.6 |
| 19 | CTM-1 | Polycarbonate | 9.9 | Toluene | 8.9 | −1.0 | Tetrahydrofuran | 9.3 | −0.6 |
| 20 | CTM-1 | Polycarbonate | 9.9 | Cyclohexane | 8.2 | −1.7 | 2-Butanol | 10.8 | 0.9 |
| 21 | CTM-1 | Polycarbonate | 9.9 | Cyclohexane | 8.2 | −1.7 | Tetrahydrofuran | 9.3 | −0.6 |
| 22 | CTM-1 | Polycarbonate | 9.9 | None | | | Tetrahydrofuran | 9.3 | −0.6 |
| 23 | CTM-1 | Polycarbonate | 9.9 | Cyclohexane | 8.2 | −1.7 | Tetrahydrofuran | 9.3 | −0.6 |

| | Protective layer | | | Mixed layer | |
|---|---|---|---|---|---|
| Photoreceptor | Charge transport | | Coating | Thickness | |
| No. | compound | Particles | method | [μm] | Remarks |
| 1 | T-3 | None | Slide hopper | 0.44 | Present Invention |
| 2 | T-3 | None | Slide hopper | 0.34 | Present Invention |
| 3 | T-3 | None | Slide hopper | 0.83 | Present Invention |
| 4 | T-3 | None | Slide hopper | 0.18 | Present Invention |
| 5 | T-3 | None | Slide hopper | 0.15 | Present Invention |
| 6 | T-3 | None | Slide hopper | 0.65 | Present Invention |
| 7 | T-3 | None | Slide hopper | 0.27 | Present Invention |
| 8 | T-7 | None | Slide hopper | 0.52 | Present Invention |
| 9 | T-102 | None | Slide hopper | 0.40 | Present Invention |
| 10 | T-3 | Silica | Slide hopper | 0.45 | Present Invention |
| 11 | T-3 | Silica | Slide hopper | 0.29 | Present Invention |
| 12 | T-3 | Tin oxide | Slide hopper | 0.43 | Present Invention |
| 13 | T-3 | PTFE | Slide hopper | 0.39 | Present Invention |
| 14 | T-3 | None | Dip coating | 0.71 | Present Invention |
| 15 | T-3 | None | Slide hopper | 0.37 | Present Invention |
| 16 | T-3 | Silica | Slide hopper | 0.33 | Present Invention |
| 17 | T-3 | None | Slide hopper | 0.06 | Comparative Example |
| 18 | T-3 | None | Slide hopper | 1.77 | Comparative Example |
| 19 | T-3 | None | Slide hopper | 1.42 | Comparative Example |
| 20 | T-3 | None | Slide hopper | 0.07 | Comparative Example |
| 21 | N-1 | None | Slide hopper | 0.45 | Comparative Example |
| 22 | T-3 | None | Spray coating | 0.05 | Comparative Example |
| 23 | T-3 | None | Spray coating | 0.03 | Comparative Example |

[symbol]

indicates data missing or illegible when filed

[Evaluation of Electrophotographic Photoreceptor]

Photoreceptors 1 through 23 were each mounted on a commercial full-color production printing machine, bizhub PRESS C1070 (Konica Minolta Inc.), and evaluated for wear resistance and image memory. The results are shown in the table below.

<Evaluation of Wear resistance>

The thickness of the protective layer was measured before and after the endurance test. The endurance test was conducted under the condition of printing 300,000 sheets continuously on both sides of a character image with an image ratio of 5% in A4 horizontal feed under a temperature of 23° C. and a humidity of 50% RH. The thickness of the protective layer was measured by measuring the uniform portion (excluding the portion of thickness variation at the leading and trailing edges of the coating) using a film thickness measuring instrument (EDDY560C, manufactured by HELMUT FISCHER GMBTE CO, eddy current method). The average value of the 10 random measurements was used. The difference in the thickness of the protective layer per 100 krot (100,000 rotations) before and after the endurance test was determined as the amount of wear [μm/100 krot].

<Evaluation of Image Memory>

The following image memory was evaluated before and after the endurance test under the above conditions.

Under a temperature of 10° C. and humidity of 15% RH, 20 consecutive sheets of longitudinal solid band images (images with filled-in band areas) were printed on transfer material (A3/POD gloss coated, 100 g/m², manufactured by Oji Paper), followed by 3 sheets of full-surface solid images (images with filled-in areas). The obtained full-surface solid image was evaluated for the occurrence of history in the solid band, or image memory, according to the following evaluation criteria. Using a densitometer (RD-918, Gretag-Macbeth), the reflectance density of the area of the obtained full-surface solid image that corresponds to the solid band history section and the reflectance density of the area that does not correspond to the solid band history section were measured. The difference between the two measured reflectance concentrations (ΔID) was then calculated.

(Evaluation Criteria)
A: ΔID of all solid images is less than 0.005 (Passed)
B: ΔID of the full solid image is 0.005 or more and less than 0.010 (Passed)
C: ΔID of the full solid image is 0.010 or more and less than 0.030 (Failure)
D: ΔID of the full solid image is 0.030 or more (Failure)

TABLE II

| | Protective layer | | | Evaluation result | | | |
|---|---|---|---|---|---|---|---|
| | Charge | | Mixed layer | | Image memory | | |
| Photoreceptor | transport | | Thickness | Amount of wear | Before | After | |
| No. | compound | Particles | [μm] | [μm/100 krot] | endurance test | endurance test | Remarks |
| 1 | T-3 | None | 0.44 | 0.24 | A | A | Present Invention |
| 2 | T-3 | None | 0.34 | 0.23 | A | A | Present Invention |
| 3 | T-3 | None | 0.83 | 0.34 | A | A | Present Invention |
| 4 | T-3 | None | 0.18 | 0.29 | A | B | Present Invention |
| 5 | T-3 | None | 0.15 | 0.22 | A | A | Present Invention |
| 6 | T-3 | None | 0.65 | 0.20 | A | A | Present Invention |
| 7 | T-3 | None | 0.27 | 0.25 | A | A | Present Invention |
| 8 | T-7 | None | 0.52 | 0.26 | A | A | Present Invention |
| 9 | T-102 | None | 0.40 | 0.37 | B | B | Present Invention |
| 10 | T-3 | Silica | 0.45 | 0.11 | A | A | Present Invention |
| 11 | T-3 | Silica | 0.29 | 0.08 | A | A | Present Invention |
| 12 | T-3 | Tin oxide | 0.43 | 0.13 | A | A | Present Invention |
| 13 | T-3 | PTFE | 0.39 | 0.16 | A | B | Present Invention |
| 14 | T-3 | None | 0.71 | 0.33 | A | A | Present Invention |
| 15 | T-3 | None | 0.37 | 0.28 | A | A | Present Invention |
| 16 | T-3 | Silica | 0.33 | 0.13 | A | A | Present Invention |
| 17 | T-3 | None | 0.06 | 0.27 | C | D | Comparative Example |
| 18 | T-3 | None | 1.77 | 1.55 | A | B | Comparative Example |
| 19 | T-3 | None | 1.42 | 1.32 | A | B | Comparative Example |
| 20 | T-3 | None | 0.07 | 0.24 | D | D | Comparative Example |
| 21 | N-1 | None | 0.45 | 1.85 | A | C | Comparative Example |
| 22 | T-3 | None | 0.05 | 0.40 | D | D | Comparative Example |
| 23 | T-3 | None | 0.03 | 0.35 | D | D | Comparative Example |

The above evaluation results confirm that the photoreceptor of the present invention can achieve both wear resistance and high image quality in long-term use.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

101: Conductive support
102: Intermediate layer
103: Charge generation layer
104: Charge transport layer
105: Mixed layer
106: Protective layer
100: Image forming apparatus
1, 1Y, 1M, 1C, 1Bk: Photoreceptor
2Y, 2M, 2C, 2Bk: First charging unit
3Y, 3M, 3C, 3Bk: Exposure unit
4Y, 4M, 4C, 4Bk: Developing unit
5Y, 5M, 5C, 5Bk: Primary transfer roller
5b: Secondary transfer roller
6Y, 6M, 6C, 6Bk, 6b: Cleaning unit
7: Intermediate transfer unit
8: Housing
9Y, 9M, 9C, 9Bk: Second charging unit
10Y, 10M, 10C, 10Bk: Image forming unit
21: Paper feed unit
20: Paper feed cassette
22A, 22B, 22C, 22D: Intermediate roller
23: Resist roller
24: Fixing unit
25: Discharge roller
26: Paper discharge tray
70: Intermediate transfer body
71, 72, 73, 74: Rollers
82L, 82R: Support rail
P: Transfer material

1. An electrophotographic photoreceptor having at least a charge transport layer and a protective layer sequentially laminated on a conductive support,
wherein the protective layer contains a cured product of a composition containing a charge transport compound having a chain polymerizable functional group; the charge transport layer and the protective layer are continuously laminated with intervening a mixed layer therebetween in which components of both layers of the charge transport layer and the protective layer are compatible; and the mixed layer has a thickness in the range of 0.1 to 1.0 μm.

2. The electrophotographic photoreceptor according to claim 1, wherein the charge transport compound having a chain polymerizable functional group is represented by Formula (1), 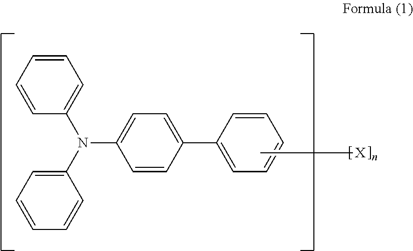
in Formula (1), a substituent X of an aryl group represents an acryloyloxy group or a methacryloyloxy group, which may have an alkylene group, an oxyalkylene group, or a polyoxyalkylene group between the aryl group, n represents an integer of 1 to 3, a hydrogen atom of the aryl group may be substituted with an alkyl group of 1 to 10 carbons, an alkoxy group of 1 to 10 carbons, or a halogeno group, in addition to the substituent X.

3. The electrophotographic photoreceptor according to claim 1, wherein the protective layer contains inorganic particles.

4. The electrophotographic photoreceptor according to claim 1, wherein the protective layer contains lubricating organic particles.

5. A method for producing an electrophotographic photoreceptor having at least a charge transport layer and a protective layer sequentially laminated on a conductive support, the method comprising a step of applying a protective layer-forming coating liquid for forming the protective layer onto the charge transport layer containing at least a binder resin; the protective layer-forming coating liquid contains at least a charge transport compound having a chain polymerizable functional group, Solvent 1, and Solvent 2; and a solubility parameter δ_{B} [(cal/cm³)^{1/2}] of the binder resin, a solubility parameter δ_{S1} [(cal/cm³)^{1/2}] of Solvent 1, and a solubility parameter δ_{S2} [(cal/cm³)^{1/2}] of Solvent 2 satisfy the following Expression 1 and Expression 2,
−3.3≤δ_{S1}−δ_{B}≤−1.3 Expression 1:
−1.3<δ_{S2}−δ_{B}≤0.7. Expression 2:

6. The method for producing an electrophotographic photoreceptor according to claim 5, wherein a coating method for forming the protective layer is a slide hopper method or a dip coating method.

7. An image forming apparatus equipped with the electrophotographic photoreceptor according to claim 1.
